(19) United States
(12) Patent Application Publication
(10) Pub. No.: US 2023/0388508 A1
(43) Pub. Date: Nov. 30, 2023

(54) METHOD AND DEVICE FOR GENERATING MEDIA FILE

(71) Applicant: LG Electronics Inc., Seoul (KR)

(72) Inventor: Hendry HENDRY, Seoul (KR)

(21) Appl. No.: 18/245,946

(22) PCT Filed: Sep. 29, 2021
(86) PCT No.: PCT/KR2021/013308

§ 371 Date: Mar. 20, 2023

Related U.S. Application Data
(60) Provisional application No. 63/084,581, filed on Sep. 29, 2020.

(51) Int. Cl. H04N 19/132; H04N 19/17; H04N 19/46

(52) U.S. Cl. CPC H04N 19/132; H04N 19/17; H04N 19/46

(57) ABSTRACT

A method for generating a media file according to an embodiment of the present document may comprise the steps of: storing video information in tracks of a file format; configuring information related to an operating point in the file format; and generating a media file on the basis of the file format. The file format may include information on the maximum picture width with respect to the operating point and information on the maximum picture height with respect to the operating point. Accordingly, the information on the maximum picture width and the information on the maximum picture height may be used to select the operating point.

### TECHNICAL FIELD

The present disclosure relates to image coding technology, and more particularly, to a method and apparatus for generating and/or processing a media file for coded image information in an image coding system.

### BACKGROUND ART

Recently, demand for high-resolution, high-quality images, such as High Definition (HD) images and Ultra High Definition (UHD) images, has been increasing in various fields. As the image data has high resolution and high quality, the amount of information or bits to be transmitted increases relative to the legacy image data. Therefore, when image data is transmitted using a medium such as a conventional wired/wireless broadband line or image data is stored using an existing storage medium, the transmission cost and the storage cost thereof are increased.

Accordingly, there is a need for a highly efficient image compression technique for effectively transmitting, storing, and reproducing information of high-resolution and high-quality images.

### DISCLOSURE

### Technical Solution

According to one embodiment of the present disclosure, a method for generating a media file is provided. The method may be performed by a media file generating apparatus. The method may comprise storing the video information in tracks of a file format, configuring an operating point entity group including information related to an operating point in the file format, and generating the media file based on the file format. For example, the operating point entity group may include information on a maximum picture width for the operating point and information on a maximum picture height for the operating point, and the information on the maximum picture width and the information on the maximum picture height may be used to select the operating point.

According to another embodiment of the present disclosure, a media file generating apparatus is provided. The media file generating apparatus may comprise an image processor storing the video information in tracks of a file format and configuring an operating point entity group including information related to an operating point in the file format and a media file generator generating the media file based on the file format. For example, the operating point entity group may include information on a maximum picture width for the operating point and information on a maximum picture height for the operating point, and the information on the maximum picture width and the information on the maximum picture height may be used to select the operating point.

According to another embodiment of the present disclosure, a method for generating a media file is provided. The method may be performed by a media file generating apparatus. The method may comprise storing the video information in tracks of a file format, configuring an operating point information sample group including information related to an operating point in the file format, and generating the media file based on the file format. For example, the operating point information sample group may include information on a maximum picture width for the operating point and information on a maximum picture height for the operating point, and the information on the maximum picture width and the information on the maximum picture height may be used to select the operating point.

According to another embodiment of the present disclosure, a media file generating apparatus is provided. The media file generating apparatus may comprise an image processor storing the video information in tracks of a file format and configuring an operating point information sample group including information related to an operating point in the file format and a media file generator generating the media file. For example, the operating point information sample group may include information on a maximum picture width for the operating point and information on a maximum picture height for the operating point, and the information on the maximum picture width and the information on the maximum picture height may be used to select the operating point.

According to another embodiment of the present disclosure, a method for processing a media file is provided. The method may be performed by an apparatus for processing a media file. The method may comprise deriving an operating point entity group from the media file, selecting an operating point based on the operating point entity group, and reconstructing the video information based on the operating point. The operating point entity group may include information on a maximum picture width for the operating point and information on a maximum picture height for the operating point, and the information on the maximum picture width and the information on the maximum picture height may be used to select the operating point.

According to another embodiment of the present disclosure, an apparatus for processing a media file is provided. The apparatus for processing the media file may comprise a receiver obtaining a media file and an media file processor deriving an operating point entity group from the media file, selecting an operating point based on the operating point entity group, and reconstructing the video information based on the operating point. The operating point entity group may include information on a maximum picture width for the operating point and information on a maximum picture height for the operating point, and the information on the maximum picture width and the information on the maximum picture height may be used to select the operating point.

According to another embodiment of the present disclosure, a computer-readable digital storage medium in which a media file is stored is provided. The method of generating the media file may comprise storing the video information in tracks of a file format, configuring an operating point entity group including information related to an operating point in the file format, and generating the media file based on the file format. For example, the operating point entity group may include information on a maximum picture width for the operating point and information on a maximum picture height for the operating point, and the information on the maximum picture width and the information on the maximum picture height may be used to select the operating point.

According to another embodiment of the present disclosure, a computer-readable digital storage medium in which a media file is stored is provided. The method of generating a media file may comprise storing the video information in tracks of a file format, configuring an operating point information sample group including information related to an operating point in the file format, and generating the media file based on the file format. For example, the operating point information sample group may include information on a maximum picture width for the operating point and information on a maximum picture height for the operating point, and the information on the maximum picture width and the information on the maximum picture height may be used to select the operating point.

### TECHNICAL EFFECTS

According to the embodiments of the present disclosure, a picture size for each output layer set is provided, and it may be used as one of the aspects to be considered when selecting an operating point.

According to the embodiments of the present disclosure, it is possible to select an operating point suitable for the size of an output picture, and accordingly, the accuracy of picture reconstruction may be increased and the subjective/objective quality of a reconstructed picture may be improved.

### DESCRIPTION OF DIAGRAMS

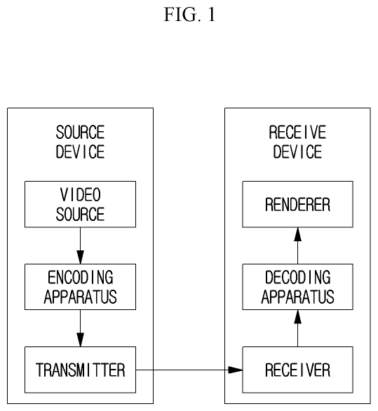

FIG. 1 briefly illustrates an example of a video/image coding device to which embodiments of the present disclosure are applicable.

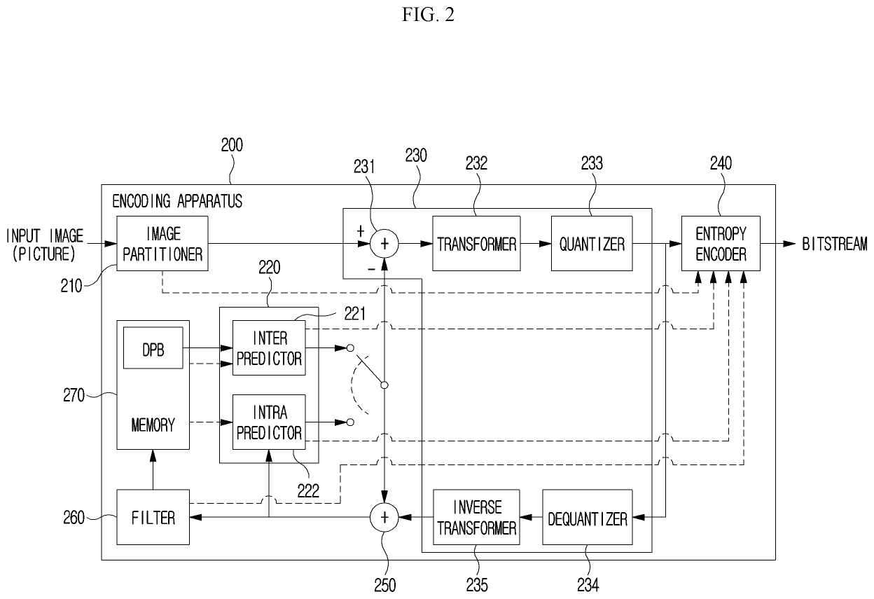

FIG. 2 is a schematic diagram illustrating a configuration of a video/image encoding apparatus to which the embodiments of the present disclosure may be applied.

FIG. 3 is a schematic diagram illustrating a configuration of a video/image decoding apparatus to which the embodiments of the present disclosure may be applied.

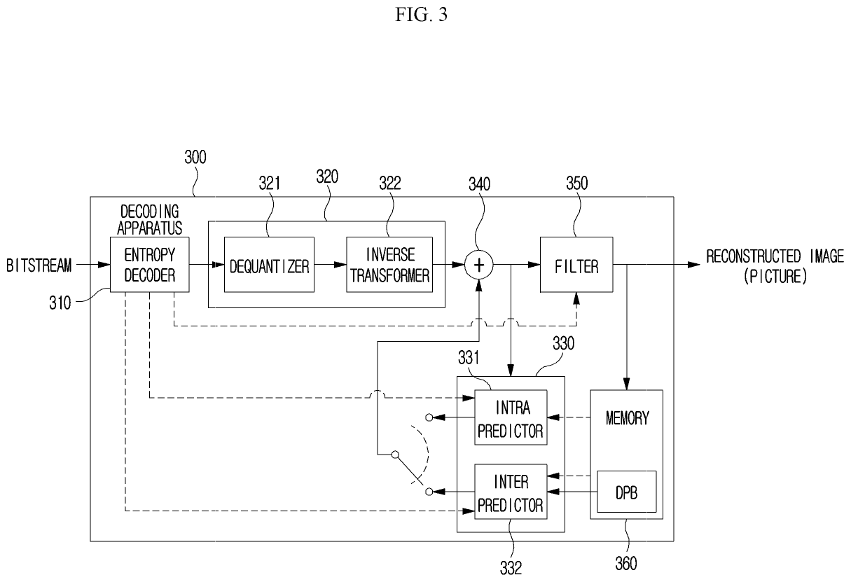

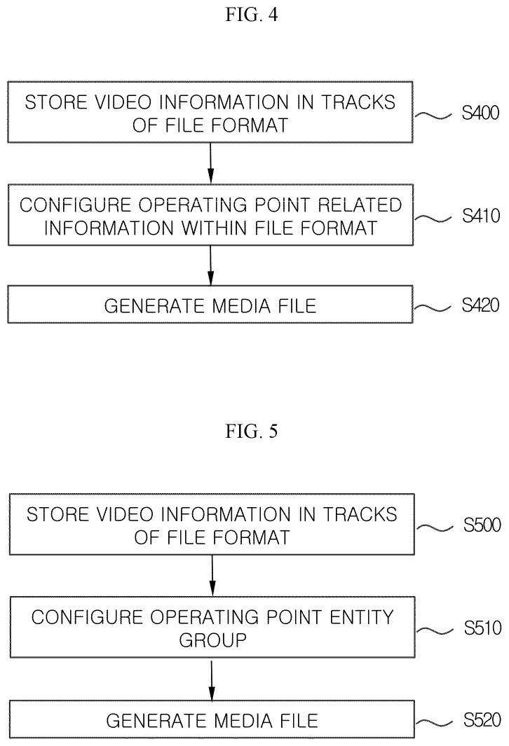

FIG. 4 briefly illustrates a method of generating a media file according to an embodiment of the present disclosure.

FIG. 5 briefly illustrates a method of generating a media file according to another embodiment of the present disclosure.

FIG. 6 briefly illustrates a method of generating a media file according to another embodiment of the present disclosure.

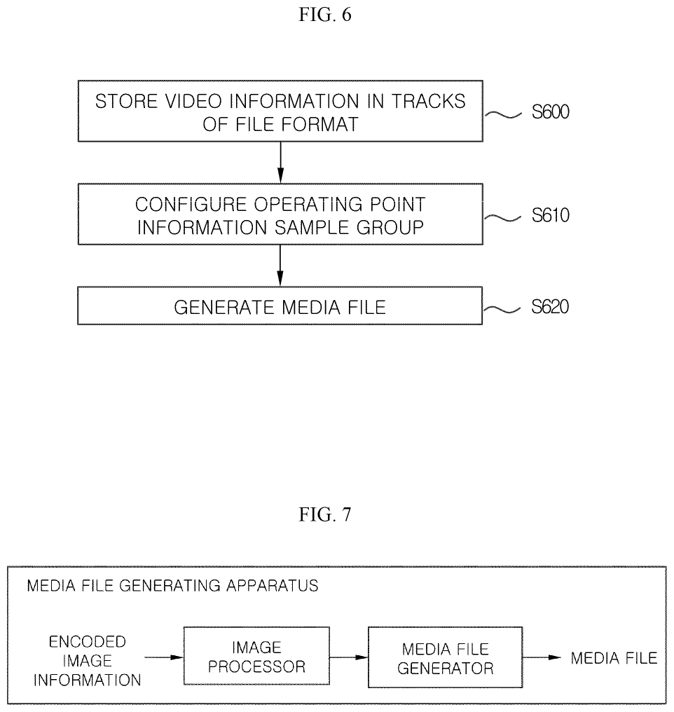

FIG. 7 briefly illustrates a media file generating apparatus according to the present disclosure.

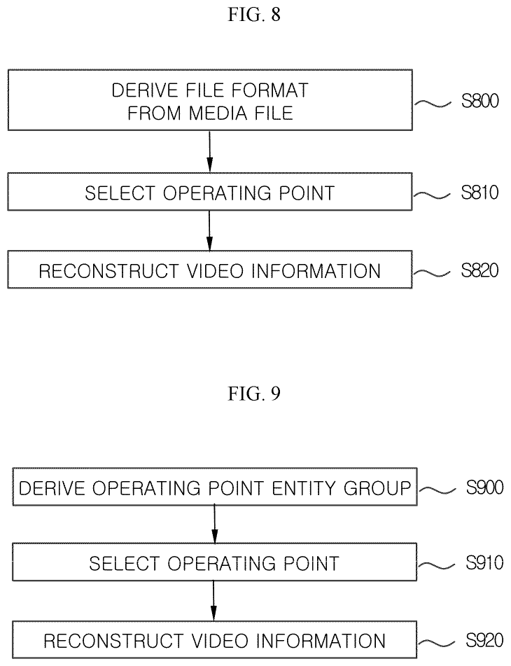

FIG. 8 briefly illustrates a method of processing a media file according to an embodiment of the present disclosure.

FIG. 9 briefly illustrates a method of processing a media file according to another embodiment of the present disclosure.

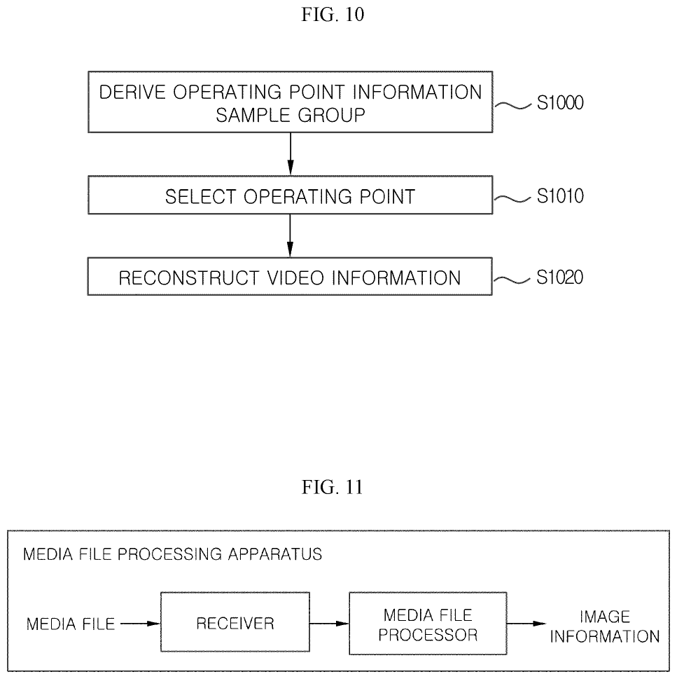

FIG. 10 briefly illustrates a method of processing a media file according to another embodiment of the present disclosure.

FIG. 11 briefly illustrates an apparatus of processing a media file according to the present disclosure.

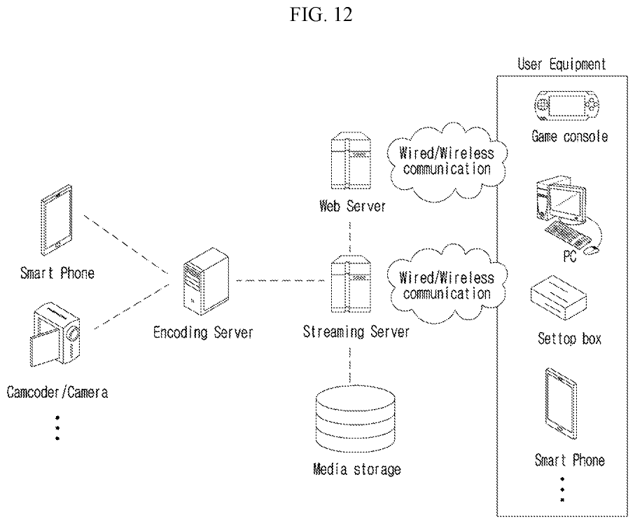

FIG. 12 illustrates a structural diagram of a contents streaming system to which the present disclosure is applied.

### BEST MODE

The present disclosure may be modified in various forms, and specific embodiments thereof will be described and illustrated in the drawings. However, the embodiments are not intended for limiting the disclosure. The terms used in the following description are used to merely describe specific embodiments but are not intended to limit the disclosure. An expression of a singular number includes an expression of the plural number, so long as it is clearly read differently. The terms such as “include” and “have” are intended to indicate that features, numbers, steps, operations, elements, components, or combinations thereof used in the following description exist and it should be thus understood that the possibility of existence or addition of one or more different features, numbers, steps, operations, elements, components, or combinations thereof is not excluded.

Meanwhile, elements in the drawings described in the disclosure are independently drawn for the purpose of convenience for explanation of different specific functions, and do not mean that the elements are embodied by independent hardware or independent software. For example, two or more elements of the elements may be combined to form a single element, or one element may be partitioned into plural elements. The embodiments in which the elements are combined and/or partitioned belong to the disclosure without departing from the concept of the disclosure.

Hereinafter, embodiments of the present disclosure will be described in detail with reference to the accompanying drawings. In addition, like reference numerals are used to indicate like elements throughout the drawings, and the same descriptions on the like elements will be omitted.

FIG. 1 briefly illustrates an example of a video/image coding device to which embodiments of the present disclosure are applicable.

Referring to FIG. 1, a video/image coding system may include a first device (source device) and a second device (receiving device). The source device may deliver encoded video/image information or data in the form of a file or streaming to the receiving device via a digital storage medium or network.

The source device may include a video source, an encoding apparatus, and a transmitter. The receiving device may include a receiver, a decoding apparatus, and a renderer. The encoding apparatus may be called a video/image encoding apparatus, and the decoding apparatus may be called a video/image decoding apparatus. The transmitter may be included in the encoding apparatus. The receiver may be included in the decoding apparatus. The renderer may include a display, and the display may be configured as a separate device or an external component.

The video source may acquire video/image through a process of capturing, synthesizing, or generating the video/image. The video source may include a video/image capture device and/or a video/image generating device. The video/image capture device may include, for example, one or more cameras, video/image archives including previously captured video/images, and the like. The video/image generating device may include, for example, computers, tablets and smartphones, and may (electronically) generate video/images. For example, a virtual video/image may be generated through a computer or the like. In this case, the video/image capturing process may be replaced by a process of generating related data.

The encoding apparatus may encode input image/image. The encoding apparatus may perform a series of procedures such as prediction, transform, and quantization for compression and coding efficiency. The encoded data (encoded video/image information) may be output in the form of a bit stream.

The transmitter may transmit the encoded image/image information or data output in the form of a bit stream to the receiver of the receiving device through a digital storage medium or a network in the form of a file or streaming. The digital storage medium may include various storage mediums such as USB, SD, CD, DVD, Blu-ray, HDD, SSD, and the like. The transmitter may include an element for generating a media file through a predetermined file format and may include an element for transmission through a broadcast/communication network. The receiver may receive/extract the bit stream and transmit the received bit stream to the decoding apparatus.

The decoding apparatus may decode the video/image by performing a series of procedures such as dequantization, inverse transform, and prediction corresponding to the operation of the encoding apparatus.

The renderer may render the decoded video/image. The rendered video/image may be displayed through the display.

Present disclosure relates to video/image coding. For example, the methods/embodiments disclosed in the present disclosure may be applied to a method disclosed in the versatile video coding (VVC), the EVC (essential video coding) standard, the AOMedia Video 1 (AV1) standard, the 2nd generation of audio video coding standard (AVS2), or the next generation video/image coding standard (e.g., H.267 or H.268, etc.).

Present disclosure presents various embodiments of video/image coding, and the embodiments may be performed in combination with each other unless otherwise mentioned.

In the present disclosure, video may refer to a series of images over time. Picture generally refers to a unit representing one image in a specific time zone, and a subpicture/slice/tile is a unit constituting part of a picture in coding. The subpicture/slice/tile may include one or more coding tree units (CTUs). One picture may consist of one or more subpictures/slices/tiles. One picture may consist of one or more tile groups. One tile group may include one or more tiles. A brick may represent a rectangular region of CTU rows within a tile in a picture. A tile may be partitioned into multiple bricks, each of which consisting of one or more CTU rows within the tile. A tile that is not partitioned into multiple bricks may be also referred to as a brick. A brick scan is a specific sequential ordering of CTUs partitioning a picture in which the CTUs are ordered consecutively in CTU raster scan in a brick, bricks within a tile are ordered consecutively in a raster scan of the bricks of the tile, and tiles in a picture are ordered consecutively in a raster scan of the tiles of the picture. In addition, a subpicture may represent a rectangular region of one or more slices within a picture. That is, a subpicture contains one or more slices that collectively cover a rectangular region of a picture. A tile is a rectangular region of CTUs within a particular tile column and a particular tile row in a picture. The tile column is a rectangular region of CTUs having a height equal to the height of the picture and a width specified by syntax elements in the picture parameter set. The tile row is a rectangular region of CTUs having a height specified by syntax elements in the picture parameter set and a width equal to the width of the picture. A tile scan is a specific sequential ordering of CTUs partitioning a picture in which the CTUs are ordered consecutively in CTU raster scan in a tile whereas tiles in a picture are ordered consecutively in a raster scan of the tiles of the picture. A slice includes an integer number of bricks of a picture that may be exclusively contained in a single NAL unit. A slice may consist of either a number of complete tiles or only a consecutive sequence of complete bricks of one tile. Tile groups and slices may be used interchangeably in the present disclosure. For example, in the present disclosure, a tile group/tile group header may be called a slice/slice header.

A pixel or a pel may mean a smallest unit constituting one picture (or image). Also, ‘sample’ may be used as a term corresponding to a pixel. A sample may generally represent a pixel or a value of a pixel, and may represent only a pixel/pixel value of a luma component or only a pixel/pixel value of a chroma component.

A unit may represent a basic unit of image processing. The unit may include at least one of a specific region of the picture and information related to the region. One unit may include one luma block and two chroma (e.g., cb, cr) blocks. The unit may be used interchangeably with terms such as block or area in some cases. In a general case, an M×N block may include samples (or sample arrays) or a set (or array) of transform coefficients of M columns and N rows.

In the present description, “A or B” may mean “only A”, “only B” or “both A and B”. In other words, in the present specification, “A or B” may be interpreted as “A and/or B”. For example, “A, B or C” herein means “only A”, “only B”, “only C”, or “any and any combination of A, B and C”.

A slash (/) or a comma (comma) used in the present description may mean “and/or”. For example, “A/B” may mean “A and/or B”. Accordingly, “A/B” may mean “only A”, “only B”, or “both A and B”. For example, “A, B, C” may mean “A, B, or C”.

In the present description, “at least one of A and B” may mean “only A”, “only B”, or “both A and B”. In addition, in the present description, the expression “at least one of A or B” or “at least one of A and/or B” may be interpreted the same as “at least one of A and B”.

In addition, in the present description, “at least one of A, B and C” means “only A”, “only B”, “only C”, or “any combination of A, B and C”. Also, “at least one of A, B or C” or “at least one of A, B and/or C” may mean “at least one of A, B and C”.

In addition, parentheses used in the present description may mean “for example”. Specifically, when “prediction (intra prediction)” is indicated, “intra prediction” may be proposed as an example of “prediction”. In other words, “prediction” in the present description is not limited to “intra prediction”, and “intra prediction” may be proposed as an example of “prediction”. Also, even when “prediction (i.e., intra prediction)” is indicated, “intra prediction” may be proposed as an example of “prediction”.

In the present description, technical features that are individually described within one drawing may be implemented individually or may be implemented at the same time.

The following drawings were created to explain a specific example of the present description. Since the names of specific devices described in the drawings or the names of specific signals/messages/fields are presented by way of example, the technical features of the present description are not limited to the specific names used in the following drawings.

FIG. 2 is a schematic diagram illustrating a configuration of a video/image encoding apparatus to which the embodiment(s) of the present disclosure may be applied. Hereinafter, the video encoding apparatus may include an image encoding apparatus.

Referring to FIG. 2, the encoding apparatus 200 includes an image partitioner 210, a predictor 220, a residual processor 230, and an entropy encoder 240, an adder 250, a filter 260, and a memory 270. The predictor 220 may include an inter predictor 221 and an intra predictor 222. The residual processor 230 may include a transformer 232, a quantizer 233, a dequantizer 234, and an inverse transformer 235. The residual processor 230 may further include a subtractor 231. The adder 250 may be called a reconstructor or a reconstructed block generator. The image partitioner 210, the predictor 220, the residual processor 230, the entropy encoder 240, the adder 250, and the filter 260 may be configured by at least one hardware component (e.g., an encoder chipset or processor) according to an embodiment. In addition, the memory 270 may include a decoded picture buffer (DPB) or may be configured by a digital storage medium. The hardware component may further include the memory 270 as an internal/external component.

The image partitioner 210 may partition an input image (or a picture or a frame) input to the encoding apparatus 200 into one or more processors. For example, the processor may be called a coding unit (CU). In this case, the coding unit may be recursively partitioned according to a quad-tree binary-tree ternary-tree (QTBTTT) structure from a coding tree unit (CTU) or a largest coding unit (LCU). For example, one coding unit may be partitioned into a plurality of coding units of a deeper depth based on a quad tree structure, a binary tree structure, and/or a ternary structure. In this case, for example, the quad tree structure may be applied first and the binary tree structure and/or ternary structure may be applied later. Alternatively, the binary tree structure may be applied first. The coding procedure according to the present disclosure may be performed based on the final coding unit that is no longer partitioned. In this case, the largest coding unit may be used as the final coding unit based on coding efficiency according to image characteristics, or if necessary, the coding unit may be recursively partitioned into coding units of deeper depth and a coding unit having an optimal size may be used as the final coding unit. Here, the coding procedure may include a procedure of prediction, transform, and reconstruction, which will be described later. As another example, the processor may further include a prediction unit (PU) or a transform unit (TU). In this case, the prediction unit and the transform unit may be split or partitioned from the aforementioned final coding unit. The prediction unit may be a unit of sample prediction, and the transform unit may be a unit for deriving a transform coefficient and/or a unit for deriving a residual signal from the transform coefficient.

The unit may be used interchangeably with terms such as block or area in some cases. In a general case, an M×N block may represent a set of samples or transform coefficients composed of M columns and N rows. A sample may generally represent a pixel or a value of a pixel, may represent only a pixel/pixel value of a luma component or represent only a pixel/pixel value of a chroma component. A sample may be used as a term corresponding to one picture (or image) for a pixel or a pel.

In the encoding apparatus 200, a prediction signal (predicted block, prediction sample array) output from the inter predictor 221 or the intra predictor 222 is subtracted from an input image signal (original block, original sample array) to generate a residual signal residual block, residual sample array), and the generated residual signal is transmitted to the transformer 232. In this case, as shown, a unit for subtracting a prediction signal (predicted block, prediction sample array) from the input image signal (original block, original sample array) in the encoder 200 may be called a subtractor 231. The predictor may perform prediction on a block to be processed (hereinafter, referred to as a current block) and generate a predicted block including prediction samples for the current block. The predictor may determine whether intra prediction or inter prediction is applied on a current block or CU basis. As described later in the description of each prediction mode, the predictor may generate various information related to prediction, such as prediction mode information, and transmit the generated information to the entropy encoder 240. The information on the prediction may be encoded in the entropy encoder 240 and output in the form of a bit stream.

The intra predictor 222 may predict the current block by referring to the samples in the current picture. The referred samples may be located in the neighborhood of the current block or may be located apart according to the prediction mode. In the intra prediction, prediction modes may include a plurality of non-directional modes and a plurality of directional modes. The non-directional mode may include, for example, a DC mode and a planar mode. The directional mode may include, for example, 33 directional prediction modes or 65 directional prediction modes according to the degree of detail of the prediction direction. However, this is merely an example, more or less directional prediction modes may be used depending on a setting. The intra predictor 222 may determine the prediction mode applied to the current block by using a prediction mode applied to a neighboring block.

The inter predictor 221 may derive a predicted block for the current block based on a reference block (reference sample array) specified by a motion vector on a reference picture. Here, in order to reduce the amount of motion information transmitted in the inter prediction mode, the motion information may be predicted in units of blocks, sub-blocks, or samples based on correlation of motion information between the neighboring block and the current block. The motion information may include a motion vector and a reference picture index. The motion information may further include inter prediction direction (L0 prediction, L1 prediction, Bi prediction, etc.) information. In the case of inter prediction, the neighboring block may include a spatial neighboring block present in the current picture and a temporal neighboring block present in the reference picture. The reference picture including the reference block and the reference picture including the temporal neighboring block may be the same or different. The temporal neighboring block may be called a collocated reference block, a co-located CU (colCU), and the like, and the reference picture including the temporal neighboring block may be called a collocated picture (colPic). For example, the inter predictor 221 may configure a motion information candidate list based on neighboring blocks and generate information indicating which candidate is used to derive a motion vector and/or a reference picture index of the current block. Inter prediction may be performed based on various prediction modes. For example, in the case of a skip mode and a merge mode, the inter predictor 221 may use motion information of the neighboring block as motion information of the current block. In the skip mode, unlike the merge mode, the residual signal may not be transmitted. In the case of the motion vector prediction (MVP) mode, the motion vector of the neighboring block may be used as a motion vector predictor and the motion vector of the current block may be indicated by signaling a motion vector difference.

The predictor 220 may generate a prediction signal based on various prediction methods described below. For example, the predictor may not only apply intra prediction or inter prediction to predict one block but also simultaneously apply both intra prediction and inter prediction. This may be called combined inter and intra prediction (CIP). In addition, the predictor may be based on an intra block copy (IBC) prediction mode or a palette mode for prediction of a block. The IBC prediction mode or palette mode may be used for content image/video coding of a game or the like, for example, screen content coding (SCC). The IBC basically performs prediction in the current picture but may be performed similarly to inter prediction in that a reference block is derived in the current picture. That is, the IBC may use at least one of the inter prediction techniques described in the present disclosure. The palette mode may be considered as an example of intra coding or intra prediction. When the palette mode is applied, a sample value within a picture may be signaled based on information on the palette table and the palette index.

The prediction signal generated by the predictor (including the inter predictor 221 and/or the intra predictor 222) may be used to generate a reconstructed signal or to generate a residual signal. The transformer 232 may generate transform coefficients by applying a transform technique to the residual signal. For example, the transform technique may include at least one of a discrete cosine transform (DCT), a discrete sine transform (DST), a Karhunen-loeve transform (KLT), a graph-based transform (GBT), or a conditionally non-linear transform (CNT). Here, the GBT means transform obtained from a graph when relationship information between pixels is represented by the graph. The CNT refers to transform generated based on a prediction signal generated using all previously reconstructed pixels. In addition, the transform process may be applied to square pixel blocks having the same size or may be applied to blocks having a variable size rather than square.

The quantizer 233 may quantize the transform coefficients and transmit them to the entropy encoder 240 and the entropy encoder 240 may encode the quantized signal (information on the quantized transform coefficients) and output a bit stream. The information on the quantized transform coefficients may be referred to as residual information. The quantizer 233 may rearrange block type quantized transform coefficients into a one-dimensional vector form based on a coefficient scanning order and generate information on the quantized transform coefficients based on the quantized transform coefficients in the one-dimensional vector form. Information on transform coefficients may be generated. The entropy encoder 240 may perform various encoding methods such as, for example, exponential Golomb, context-adaptive variable length coding (CAVLC), context-adaptive binary arithmetic coding (CABAC), and the like. The entropy encoder 240 may encode information necessary for video/image reconstruction other than quantized transform coefficients (e.g., values of syntax elements, etc.) together or separately. Encoded information (e.g., encoded video/image information) may be transmitted or stored in units of NALs (network abstraction layer) in the form of a bit stream. The video/image information may further include information on various parameter sets such as an adaptation parameter set (APS), a picture parameter set (PPS), a sequence parameter set (SPS), or a video parameter set (VPS). In addition, the video/image information may further include general constraint information. In the present disclosure, information and/or syntax elements transmitted/signaled from the encoding apparatus to the decoding apparatus may be included in video/picture information. The video/image information may be encoded through the above-described encoding procedure and included in the bit stream. The bit stream may be transmitted over a network or may be stored in a digital storage medium. The network may include a broadcasting network and/or a communication network, and the digital storage medium may include various storage media such as USB, SD, CD, DVD, Blu-ray, HDD, SSD, and the like. A transmitter (not shown) transmitting a signal output from the entropy encoder 240 and/or a storage unit (not shown) storing the signal may be included as internal/external element of the encoding apparatus 200, and alternatively, the transmitter may be included in the entropy encoder 240.

The quantized transform coefficients output from the quantizer 233 may be used to generate a prediction signal. For example, the residual signal (residual block or residual samples) may be reconstructed by applying dequantization and inverse transform to the quantized transform coefficients through the dequantizer 234 and the inverse transformer 235. The adder 250 adds the reconstructed residual signal to the prediction signal output from the inter predictor 221 or the intra predictor 222 to generate a reconstructed signal (reconstructed picture, reconstructed block, reconstructed sample array). If there is no residual for the block to be processed, such as a case where the skip mode is applied, the predicted block may be used as the reconstructed block. The adder 250 may be called a reconstructor or a reconstructed block generator. The generated reconstructed signal may be used for intra prediction of a next block to be processed in the current picture and may be used for inter prediction of a next picture through filtering as described below.

Meanwhile, luma mapping with chroma scaling (LMCS) may be applied during picture encoding and/or reconstruction.

The filter 260 may improve subjective/objective image quality by applying filtering to the reconstructed signal. For example, the filter 260 may generate a modified reconstructed picture by applying various filtering methods to the reconstructed picture and store the modified reconstructed picture in the memory 270, specifically, a DPB of the memory 270. The various filtering methods may include, for example, deblocking filtering, a sample adaptive offset, an adaptive loop filter, a bilateral filter, and the like. The filter 260 may generate various information related to the filtering and transmit the generated information to the entropy encoder 240 as described later in the description of each filtering method. The information related to the filtering may be encoded by the entropy encoder 240 and output in the form of a bit stream.

The modified reconstructed picture transmitted to the memory 270 may be used as the reference picture in the inter predictor 221. When the inter prediction is applied through the encoding apparatus, prediction mismatch between the encoding apparatus 200 and the decoding apparatus 300 may be avoided and encoding efficiency may be improved.

The DPB of the memory 270 DPB may store the modified reconstructed picture for use as a reference picture in the inter predictor 221. The memory 270 may store the motion information of the block from which the motion information in the current picture is derived (or encoded) and/or the motion information of the blocks in the picture that have already been reconstructed. The stored motion information may be transmitted to the inter predictor 221 and used as the motion information of the spatial neighboring block or the motion information of the temporal neighboring block. The memory 270 may store reconstructed samples of reconstructed blocks in the current picture and may transfer the reconstructed samples to the intra predictor 222.

FIG. 3 is a schematic diagram illustrating a configuration of a video/image decoding apparatus to which the embodiment(s) of the present disclosure may be applied.

Referring to FIG. 3, the decoding apparatus 300 may include an entropy decoder 310, a residual processor 320, a predictor 330, an adder 340, a filter 350, and a memory 360. The predictor 330 may include an inter predictor 331 and an intra predictor 332. The residual processor 320 may include a dequantizer 321 and an inverse transformer 322. The entropy decoder 310, the residual processor 320, the predictor 330, the adder 340, and the filter 350 may be configured by a hardware component (e.g., a decoder chipset or a processor) according to an embodiment. In addition, the memory 360 may include a decoded picture buffer (DPB) or may be configured by a digital storage medium. The hardware component may further include the memory 360 as an internal/external component.

When a bit stream including video/image information is input, the decoding apparatus 300 may reconstruct an image corresponding to a process in which the video/image information is processed in the encoding apparatus of FIG. 2. For example, the decoding apparatus 300 may derive units/blocks based on block partition related information obtained from the bit stream. The decoding apparatus 300 may perform decoding using a processor applied in the encoding apparatus. Thus, the processor of decoding may be a coding unit, for example, and the coding unit may be partitioned according to a quad tree structure, binary tree structure and/or ternary tree structure from the coding tree unit or the largest coding unit. One or more transform units may be derived from the coding unit. The reconstructed image signal decoded and output through the decoding apparatus 300 may be reproduced through a reproducing apparatus.

The decoding apparatus 300 may receive a signal output from the encoding apparatus of FIG. 2 in the form of a bit stream, and the received signal may be decoded through the entropy decoder 310. For example, the entropy decoder 310 may parse the bit stream to derive information (e.g., video/image information) necessary for image reconstruction (or picture reconstruction). The video/image information may further include information on various parameter sets such as an adaptation parameter set (APS), a picture parameter set (PPS), a sequence parameter set (SPS), or a video parameter set (VPS). In addition, the video/image information may further include general constraint information. The decoding apparatus may further decode picture based on the information on the parameter set and/or the general constraint information. Signaled/received information and/or syntax elements described later in the present disclosure may be decoded may decode the decoding procedure and obtained from the bit stream. For example, the entropy decoder 310 decodes the information in the bit stream based on a coding method such as exponential Golomb coding, CAVLC, or CABAC, and output syntax elements required for image reconstruction and quantized values of transform coefficients for residual. More specifically, the CABAC entropy decoding method may receive a bin corresponding to each syntax element in the bit stream, determine a context model using a decoding target syntax element information, decoding information of a decoding target block or information of a symbol/bin decoded in a previous stage, and perform an arithmetic decoding on the bin by predicting a probability of occurrence of a bin according to the determined context model, and generate a symbol corresponding to the value of each syntax element. In this case, the CABAC entropy decoding method may update the context model by using the information of the decoded symbol/bin for a context model of a next symbol/bin after determining the context model. The information related to the prediction among the information decoded by the entropy decoder 310 may be provided to the predictor (the inter predictor 332 and the intra predictor 331), and the residual value on which the entropy decoding was performed in the entropy decoder 310, that is, the quantized transform coefficients and related parameter information, may be input to the residual processor 320. The residual processor 320 may derive the residual signal (the residual block, the residual samples, the residual sample array). In addition, information on filtering among information decoded by the entropy decoder 310 may be provided to the filter 350. Meanwhile, a receiver (not shown) for receiving a signal output from the encoding apparatus may be further configured as an internal/external element of the decoding apparatus 300, or the receiver may be a component of the entropy decoder 310. Meanwhile, the decoding apparatus according to the present disclosure may be referred to as a video/image/picture decoding apparatus, and the decoding apparatus may be classified into an information decoder (video/image/picture information decoder) and a sample decoder (video/image/picture sample decoder). The information decoder may include the entropy decoder 310, and the sample decoder may include at least one of the dequantizer 321, the inverse transformer 322, the adder 340, the filter 350, the memory 360, the inter predictor 332, and the intra predictor 331.

The dequantizer 321 may dequantize the quantized transform coefficients and output the transform coefficients. The dequantizer 321 may rearrange the quantized transform coefficients in the form of a two-dimensional block form. In this case, the rearrangement may be performed based on the coefficient scanning order performed in the encoding apparatus. The dequantizer 321 may perform dequantization on the quantized transform coefficients by using a quantization parameter (e.g., quantization step size information) and obtain transform coefficients.

The inverse transformer 322 inversely transforms the transform coefficients to obtain a residual signal (residual block, residual sample array).

The predictor may perform prediction on the current block and generate a predicted block including prediction samples for the current block. The predictor may determine whether intra prediction or inter prediction is applied to the current block based on the information on the prediction output from the entropy decoder 310 and may determine a specific intra/inter prediction mode.

The predictor 320 may generate a prediction signal based on various prediction methods described below. For example, the predictor may not only apply intra prediction or inter prediction to predict one block but also simultaneously apply intra prediction and inter prediction. This may be called combined inter and intra prediction (CIP). In addition, the predictor may be based on an intra block copy (IBC) prediction mode or a palette mode for prediction of a block. The IBC prediction mode or palette mode may be used for content image/video coding of a game or the like, for example, screen content coding (SCC). The IBC basically performs prediction in the current picture but may be performed similarly to inter prediction in that a reference block is derived in the current picture. That is, the IBC may use at least one of the inter prediction techniques described in the present disclosure. The palette mode may be considered as an example of intra coding or intra prediction. When the palette mode is applied, a sample value within a picture may be signaled based on information on the palette table and the palette index.

The intra predictor 331 may predict the current block by referring to the samples in the current picture. The referred samples may be located in the neighborhood of the current block or may be located apart according to the prediction mode. In the intra prediction, prediction modes may include a plurality of non-directional modes and a plurality of directional modes. The intra predictor 331 may determine the prediction mode applied to the current block by using a prediction mode applied to a neighboring block.

The inter predictor 332 may derive a predicted block for the current block based on a reference block (reference sample array) specified by a motion vector on a reference picture. In this case, in order to reduce the amount of motion information transmitted in the inter prediction mode, motion information may be predicted in units of blocks, sub-blocks, or samples based on correlation of motion information between the neighboring block and the current block. The motion information may include a motion vector and a reference picture index. The motion information may further include inter prediction direction (L0 prediction, L1 prediction, Bi prediction, etc.) information. In the case of inter prediction, the neighboring block may include a spatial neighboring block present in the current picture and a temporal neighboring block present in the reference picture. For example, the inter predictor 332 may configure a motion information candidate list based on neighboring blocks and derive a motion vector of the current block and/or a reference picture index based on the received candidate selection information. Inter prediction may be performed based on various prediction modes, and the information on the prediction may include information indicating a mode of inter prediction for the current block.

The adder 340 may generate a reconstructed signal (reconstructed picture, reconstructed block, reconstructed sample array) by adding the obtained residual signal to the prediction signal (predicted block, predicted sample array) output from the predictor (including the inter predictor 332 and/or the intra predictor 331). If there is no residual for the block to be processed, such as when the skip mode is applied, the predicted block may be used as the reconstructed block.

The adder 340 may be called reconstructor or a reconstructed block generator. The generated reconstructed signal may be used for intra prediction of a next block to be processed in the current picture, may be output through filtering as described below, or may be used for inter prediction of a next picture.

Meanwhile, luma mapping with chroma scaling (LMCS) may be applied in the picture decoding process.

The filter 350 may improve subjective/objective image quality by applying filtering to the reconstructed signal. For example, the filter 350 may generate a modified reconstructed picture by applying various filtering methods to the reconstructed picture and store the modified reconstructed picture in the memory 360, specifically, a DPB of the memory 360. The various filtering methods may include, for example, deblocking filtering, a sample adaptive offset, an adaptive loop filter, a bilateral filter, and the like.

The (modified) reconstructed picture stored in the DPB of the memory 360 may be used as a reference picture in the inter predictor 332. The memory 360 may store the motion information of the block from which the motion information in the current picture is derived (or decoded) and/or the motion information of the blocks in the picture that have already been reconstructed. The stored motion information may be transmitted to the inter predictor 260 so as to be utilized as the motion information of the spatial neighboring block or the motion information of the temporal neighboring block. The memory 360 may store reconstructed samples of reconstructed blocks in the current picture and transfer the reconstructed samples to the intra predictor 331.

In the present disclosure, the embodiments described in the filter 260, the inter predictor 221, and the intra predictor 222 of the encoding apparatus 200 may be equally applied or applied correspondingly to the filter 350, the inter predictor 332, and the intra predictor 331 of the decoding apparatus 300.

Meanwhile, the above-described encoded image/video information may be configured based on a media file format to generate a media file. For example, encoded image/video information may form a media file (segment) based on one or more NAL unit/sample entries for the encoded image/video information. The media file may include a sample entry and a track. For example, a media file (segment) may include various records, and each record may include image/video related information or media file format related information. Also, for example, one or more NAL units may be stored in a configuration record (or decoder configuration record, or VVC decoder configuration record) field of a media file. Here, the field may also be called a syntax element.

For example, ISO Base Media File Format (ISOBMFF) may be used as a media file format to which the method/embodiment disclosed in the present disclosure may be applied. ISOBMFF may be used as the basis for many codec encapsulation formats such as AVC file format, HEVC file format and/or VVC file format and many multimedia container formats such as MPEG-4 file format, 3GPP file format (3GP) and/or DVB file format. Also, in addition to continuous media such as audio and video, static media such as images and metadata may be stored in a file according to ISOBMFF. A file structured according to ISOBMFF may be used for various purposes such as local media file playback, progressive downloading of a remote file, segments for Dynamic Adaptive Streaming over HTTP (DASH), containers and packetization instructions of content to be streamed, and recording of received real-time media streams.

A ‘box’ described later may be an elementary syntax element of ISOBMFF. An ISOBMFF file may consist of a sequence of boxes, and each box may contain other boxes. For example, a movie box (a box whose grouping type is ‘moov’) may include metadata for continuous media streams in a media file, and each stream may be represent as a track in a file. Metadata for a track may be included in a track box (a box whose grouping type is ‘trak’), and media content of a track may be included in a media data box (a box whose grouping type is ‘mdat’) or directly in a separate file. The media content of a track may consist of a sequence of samples, such as audio or video access units. For example, ISOBMFF may include a media track including an elementary media stream, media transmission instructions. ISOBMFF may specify types of tracks such as a hint track representing the received packet stream and a timed metadata track including time synchronized metadata.

Also, ISOBMFF is designed for storage, but is also very useful for streaming such as progressive download or DASH. For streaming purposes, movie fragments defined in ISOBMFF may be used. A fragmented ISOBMFF file may represent, for example, two tracks related to video and audio. For example, if random access is included after receiving a ‘moov’ box, all movie fragments ‘moof’ may be decoded along with related media data.

In addition, the metadata of each track may include a list of sample description entries providing a coding or encapsulation format used in the track and initialization data necessary to process the format. Also, each sample may be associated with one of the sample description entries of the track.

Using ISOBMFF, sample-specific metadata may be specified by various mechanisms. Specific boxes within a sample table box (a boxe whose grouping type is ‘stbl’) may be standardized to correspond to general requirements. For example, a sync sample box (a box whose grouping type is ‘stss’) may be used to list random access samples of a track. The sample grouping mechanism allows to map samples according to a four-character grouping type into groups of samples that share the same property specified by a sample group description entry in the file. Several grouping types may be specified in ISOBMFF.

On the other hand, a ‘sample’ described later may be all data related to a single time or single element in one of three sample arrays (Y, Cb, Cr) representing a picture. For example, when the term ‘sample’ is used in the context of a track (of a media file format), it may refer to all data related to a single time of the track. Here, the time may be a decoding time or a composition time. In addition, for example, when the term ‘sample’ is used in the context of a picture, that is, when it is used with the phrase “luma sample”, it may refer to a single element in one of the three sample arrays representing the picture.

Meanwhile, in order to store VVC content, the following three types of elementary streams may be defined.
a video elementary stream that does not include any parameter sets. Here, all parameter sets may be stored in a sample entry or sample entries.
a video and parameter set elementary stream that may include parameter sets, and may also have the parameter sets stored in their sample entry or sample entries.
a non-VCL elementary stream that includes non-VCL NAL units synchronized with the elementary stream included in a video track. Here, the VVC non-VCL track does not include a parameter set in sample entries.

Meanwhile, the operating points information of the ISO based media file format (ISOBMF) for VVC may be signaled as a sample in a group box whose grouping type is ‘vopi’ or an entity group whose grouping type is ‘opeg’. Here, the operating point may be a temporal subset of the OLS identified by an Output Layer Set (OLS) index and a highest value of TemporalId. Each operating point may be associated with a profile, tier, and level (i.e., PTL) that defines the conformance point of the operating point. The operating points information may be needed to identify a sample and a sample entry for each operating point.

Information on the constitution of the operating points may be provided to applications using various operating points and an operating point information sample group (‘vopi’) provided in a given VVC bitstream. Each operating point is associated with OLS, the maximum TemporalId value, profile, level and tier signaling. All of the above information may be captured by the ‘vopi’ sample group. Apart from the above information, the sample group may also provide dependency information between layers.

Meanwhile, when one or more VVC tracks exist for a VVC bitstream and an operating point entity group does not exist for the VVC bitstream, all of the following items may be applied.
Among the VVC tracks for the VVC bitstream, there shall be only one track that carries a ‘vopi’ sample group.
All the other VVC tracks of the VVC bitstream shall have a track reference of type ‘oref’ for the track that carries the ‘vopi’ sample group.

In addition, for any specific sample in a given track, a temporally collocated sample in another track may be defined as a sample having the same decoding time as the specific sample. For each sample SN of a track TN that has an ‘oref’ track reference for a track Tk that carries a ‘vopi’ sample group, the following may apply.
If there is a temporally collocated sample Sk in the track Tk, the sample SN may be associated with the same ‘vopi’ sample group entity as the sample Sk.
Otherwise, sample SN may be associated with the same vopi′ sample group entity as the last of samples in the track Tk that precedes sample SN in decoding time.

When several VPSs are referenced in the VVC bitstream, several entities may need to be included in a sample group description box with grouping_type ‘vopi’. In the more common case where a single VPS is present, it may be recommended to use the default sample group mechanism defined in ISO/IEC 14496-12 and include the operating point information sample group in the sample table box, rather than including it in each track fragment.

Also, grouping_type_parameter may not be defined for SampleToGroupBox whose grouping type is ‘vopi’.

The ‘vopi’ sample group including the above-described operating point information, that is, the syntax of the operating point information sample group may be as shown in the table below.

```
TABLE 1
class VvcOperatingPointsRecord {
  unsigned int (8) num_profile_tier_level_minus1;
  for (i=0; i <= num_profile_tier_level_minus1; i++) {
    unsigned int (8) ptl_max_temporal_id[i];
    VvcPTLRecord (ptl_max_temporal_id[i]+1) ptl[i];
  }
  unsigned int (1) all_independent_layers_flag;
  bit(7) reserved = 0;
  if (all_independent_layers_flag) {
  unsigned int (1) each_layer_is_an_ols_flag;
    bit(7) reserved = 0;
  } else
    unsigned int(8) ols_mode_idc;
  unsigned int(16) num)operating_points;
  for (i=0; i<num_operating_points) {
    unsigned int(16) output_layer_set_idx;
    unsigned int(8) ptl_idx;
    unsigned int(8) max_temporal_id;
    unsigned int(8) layer_count;
    for (j=0; j<layer_count; j++) {
      unsigned int(6) layer_id;
      unsigned int(1) is_outputlayer;
      bit (1) reserved = 0;
    }
    bit (6) reserved = 0;
    unsigned int(1) frame_rate_info_flag
    unsigned int(1) bit_rate_info_flag
    if (frame_rate_info_flag) {
      unsigned int(16) avgFrameRate;
      bit(6) reserved = 0;
      unsigned int(2) constantFrameRate;
    }
    if (bit_rate_info_flag) {
      unsigned int(32) maxBitRate;
      unsigned int(32) avgBitRate;
    }
  }
  unsigned int(8) max_layer_count;
  for (i=0; i<max_layer_count; i++) {
    unsigned int(8) layerID;
    unsigned int(8) num_direct_ref_layers;
    for (j=0; j<num_direct_ref_layers; j++)
      unsigned int(8) direct_ref_layerID;
    unsigned int(8) max_tid_il_ref_pics_plus1;
  }
}
class VvcOperatingPointsInformation extends VisualSampleGroupEntry
(‘vopi’) {
  VvcOperatingPointsRecord oinf;
}
```

In addition, semantics of the syntax of the operating point information sample group may be as shown in the following table.

```
TABLE 2
num_profile_tier_level_minus1 plus 1 gives the number of following
  profiles, tier, and level combinations as well as the associated fields.
ptl_max_temporal_id[i]: Gives the maximum TemporalID of NAL units of
  the associated bitstream for the specified i-th profile, tier, and level structure.
    NOTE: The semantics of ptl_max_temporal_id[i] and
    max_temporal_id of an operating point, given below, are different even
    though they may carry the same numerical value.
ptl[i] specifies the i-th profile, tier, and level structure.
all_independent_layers_flag, each_layer_is_an_ols_flag,
  ols_mode_idc and max_tid_il_ref_pics_plus1 are defined in
  ISO/IEC 23090-3.
num_operating_points: Gives the number of operating points for which the
  information follows.
output_layer_set_idx is the index of the output layer set that defines the
  operating point. The mapping between output_layer_set_idx and the
  layer_id values shall be the same as specified by the VPS for an output layer
  set with index output_layer_set_idx.
ptl_idx: Signals the zero-based index of the listed profile, level, and tier
  structure for the output layer set with index output_layer_set_idx.
max_temporal_id: Gives the maximum TemporalId of NAL units of this
  operating point.
  NOTE: The maximum TemporalId value indicated in the layer information sample
  group has different semantics from the maximum TemporalId indicated here. However,
  they may carry the same literal numerical values.
layer_count: This field indicates the number of necessary layers, as defined
  ISO/IEC 23090-3, of this operating point.
layer_id: provides the nuh_layer_id values for the layers of the operating point.
is_outputlayer: A flag that indicates if the layer is an output layer or not. A one
  indicates an output layer.
frame_rate_info_flag equal to 0 indicates that no frame rate information is
  present for the operating point. The value 1 indicates that frame rate
  information is present for the operating point.
bit_rate_info_flag equal to 0 indicates that no bitrate information is
  present for the operating point. The value 1 indicates that bitrate information is
  present for the operating point.
avg_FrameRate gives the average frame rate in units of frames/(256 seconds) for
  the operating point. Value 0 indicates an unspecified average frame rate.
constantFrameRate equal to 1 indicates that the stream of the operating point
  is of constant frame rate. Value 2 indicates that the representation of each
  temporal layer in the stream of the operating point is of constant frame rate.
  Value 0 indicates that the stream of the operating point may or may not be of
  constant frame rate.
maxBitRate gives the maximum bit rate in bits/second of the stream of the
  operating point, over any window of one second.
avgBitRate gives the average bit rate in bits/second of the stream of the
  operating point.
max_layer_count: The count of all unique layers in all of the operating points
  that relate to this associated base track.
layerID: nuh_layer_id of a layer for which the all the direct reference layers are
  given in the following loop of direct_ref_layerID.
num_direct_ref_layers: The number of direct reference layers for the layer
  with nuh_layer_id equal to layerID.
direct_ref_layerID: nuh_layer_id of the direct reference layer.
```

Also, for example, an operating point entity group may be defined to provide profile level information of the operating point and track mapping for the operating point.

In the case of aggregating samples of the track mapped to the operating point described in the operating point entity group, the implicit reconstruction process does not require removing any further NAL units to result in a conforming VVC bitstream. A track belonging to the operating point entity group shall have a track reference of type ‘oref’ for group id indicated in the operating point entity group.

In addition, all entity id values included in the operating point entity group shall belong to the same VVC bitstream. When present, OperatingPointGroupBox is included in GroupsListBox in the movie-level MetaBox and not included in the file-level or track-level MetaBox. Here, OperatingPointGroupBox may represent the operating point entity group.

The above-described syntax of the operating point entity group may be as shown in the table below.

TABLE 3

```
aligned(8) class OperatingPointGroupBox extends
EntityToGroupBox (‘opeg’,0,0)
{
  unsigned int(8) num_profile_tier_level_minus1;
  for (i=0; i<=num_profile_tier_level_minus1; i++)
    VvcPTLRecord(0) opeg_ptl[i];
  unsigned int(16) num_operating_points;
  for (i=0; i<num_operating_points) {
    unsigned int(16) output_layer_set_idx;
    unsigned int(8) ptl_idx;
    unsigned int(8) max_temporal_id;
    unsigned int(8) layer_count;
    for (j=0; j<layer_count; j++) {
      unsigned int(6) layer_id;
      unsigned int(1) is_outputlayer;
      bit(1) reserved = 0;
    }
    bit(6) reserved = 0;
    unsigned int(1) frame_rate_info_flag
    unsigned int(1) bit_rate_info_flag
    if (frame_rate_info_flag) {
      unsigned int(16) avgFrameRate;
      bit(6) reserved = 0;
      unsigned int(2) constantFrameRate;
    }
    if (bit_rate_info_flag) {
      unsigned int(32) maxBitRate;
      unsigned int(32) avgBitRate;
    }
    unsigned int(8) entity_count;
    for (j=0; j<entity_count; j++) {
      unsigned int(8) entity_idx;
    }
  }
}
```

In addition, semantics of the syntax of the operating point entity group may be as shown in the following table.

```
TABLE 4
num_profile_tier_level minus1 plus 1 gives the number of following
  profiles, tier, and level combinations as well as the associated fields.
opeg_pt1[i] specifies the i-th profile, tier, and level structure.
num_operating_points: Gives the number of operating points for which the
  information follows.
output_layer_set_idx is the index of the output layer set that defines the
  operating point. The mapping between output_layer_set_idx and the
  layer id values shall be the same as specified by the VPS for an output layer set
  with index output_layer_set_idx.
ptl_idx: Signals the zero-based index of the listed profile, level, and tier structure for
  the output layer set with index output_layer_set_idx.
max_temporal_id: Gives the maximum TemporalId of NAL units of this operating
  point.
  NOTE: The maximum TemporalId value indicated in the layer information sample group
  has different semantics from the maximum TemporalId indicated here. However, they may
  carry the same literal numerical values.
layer_count: This field indicates the number of necessary layers, as defined
  ISO/IEC 23090-3, of this operating point.
layer_id: provides the nuh_layer_id values for the layers of the operating point.
is_outputlayer: A flag that indicates if the layer is an output layer or not. A one
  indicates an output layer.
frame_rate_info_flag equal to 0 indicates that no frame rate information is
  present for the operating point. The value 1 indicates that frame rate information is
  present for the operating point.
bit_rate_info_flag equal to 0 indicates that no bitrate information is present
  for the operating point. The value 1 indicates that bitrate information is present for
  the operating point.
avgFrameRate gives the average frame rate in units of frames/(256 seconds) for the
  operating point. Value 0 indicates an unspecified average frame rate.
constantFrameRate equal to 1 indicates that the stream of the operating point is of
  constant frame rate. Value 2 indicates that the representation of each temporal layer
  in the stream of the operating point is of constant frame rate. Value 0 indicates that
  the stream of the operating point may or may not be of constant frame rate.
maxBitRate gives the maximum bit rate in bits/second of the stream of the operating
  point, over any window of one second.
avgBitRate gives the average bit rate in bits/second of the stream of the operating
  point.
entity_count specifies the number of tracks that are present in an operating point.
entity_idx specifies the index to the entity_id list in the entity group that
  belongs to an operating point.
```

Also, for example, a media file may include decoder configuration information for image/video content. That is, the media file may include a VVC decoder configuration record including decoder configuration information.

When the VVC decoder configuration record is stored in a sample entry, the VVC decoder configuration record may include the size of a length field used for each sample to indicate the length of a NAL unit included in the VVC decoder configuration record as well as parameter sets. The VVC decoder configuration record may be framed externally (the size of the VVC decoder configuration record is supplied by the structure including the VVC decoder configuration record).

In addition, the VVC decoder configuration record may include a version field. For example, a version of the present disclosure may define version 1 of the VVC decoder configuration record. Incompatible changes to the VVC decoder configuration record may be indicated by a change of version number. If the version number is not recognized, readers shall not attempt to decode the VVC decoder configuration record or the stream to which the record applies.

Compatible extensions to the VVC decoder configuration record may not change the configuration version code. A reader should be prepared to ignore unrecognized data that goes beyond the definition of data that the reader understands.

When a track includes a VVC bitstream natively or resolves through ‘subp’ track references, VvcPtlRecord shall be present in the decoder configuration record. In addition, when ptl_present_flag is 0 in the decoder configuration record of a track, the track shall have an ‘oref’ track reference.

When the stream described in the VVC decoder configuration record is decoded, values of syntax elements of VvcPTRecord, chroma_format_idc, and bit_depth_minus8 may be valid for all parameter sets that are activated. In particular, the following restrictions may apply.
Profile indication general_profile_idc indicates the profile to which the stream associated with this configuration record conforms.

Tier indication general_tier_flag may indicate a tier equal to or greater than the highest tier indicated in all the parameter sets.

Each bit in general_constraint_info may be set only if all the parameter sets set the corresponding bit.

Level indication general_level_idc may indicate a level of capability equal to or greater than the highest level indicated for the highest tier in parameter sets.

In addition, the following constraints may be applied to chroma_format_idc.
If the value of sps_chroma_format_idc defined in ISO/IEC 23090-3 is the same in all SPSs referenced by NAL units of a track, chroma_format_idc sall be equal to sps_chroma_format_idc.
Otherwise, if ptl_present_flag is equal to 1, chroma_format_idc shall be equal to vps_ols_dpb_chroma_format[output_layer_set_idx] defined in ISO/IEC 23090-3.
Otherwise (that is, if the above conditions are not satisfied), chroma_format_idc is not present.

An explicit indication may be provided in the VVC decoder configuration record about the chroma format and bit depth as well as other important format information used by the VVC video elementary stream. If the two sequences differ in color space indications in their VUI information, two different VVC sample entries may be required.

Also, for example, in the VVC decoder configuration record, there is a set of arrays to carry initialization NAL units. The NAL unit types may be restricted to indicate DCI, VPS, SPS, PPS, prefix APS and prefix SEI NAL units only. NAL unit types reserved in ISO/IEC 23090-3 and the present disclosure may be defined in the future, and the reader may have to ignore arrays with reserved or disallowed values of NAL unit types.

Meanwhile, the arrays may be in the order of DCI, VPS, SPS, PPS, prefix APS, and prefix SEI.

The syntax of the above-described VVC decoder configuration record may be as shown in the table below.

TABLE 5

```
aligned(8) class VvcPTLRecord (num_sublayers) {
  unsigned int(8) num_bytes_constraint_info;
  unsigned int(7) general_profile_idc;
  unsigned int(1) general_tier_flag;
  unsigned int(8) general_level_idc;
  unsigned int(1) ptl_frame_only_constraint_flag;
  unsigned int(1) ptl_multilayer_enabled_flag;
  if (num_bytes_constraint_info > 0)
    unsigned int(8*num_bytes_constraint_info − 2)
general_constraint_info; for (i=num_sublayers − 2; i >= 0; i−−)
    unsigned int(1) ptl_sublayer_level_present_flag[i];
  for (j=num_sublayers; j<=8 && num_sublayers > 1; j++)
    bit(1) ptl_reserved_zero_bit = 0;
  for (i=num_sublayers−2; i >= 0; i−−)
    if (ptl_sublayer_level_present[i])
      unsigned int(8) sublayer_level_idc[i];
  unsigned int(8) num_sub_profiles;
  for (j=0; j < num_sub_profiles; j++)
    unsigned int(32) general_sub_profile_idc;
}
aligned (8) class VvcDecoderConfigurationRecord {
  unsigned int(8) configurationVersion = 1;
  unsigned int(16) avgFrameRate;
  unsigned int(2) constantFrameRate;
  unsigned int(3) numTemporalLayers;
  unsigned int(2) lengthSizeMinusOne;
  unsigned int(1) ptl_present_flag;
  if (ptl_present_flag) {
    VvcPTLRecord (numTemporalLayers) track_ptl;
    unsigned int(16) output_layer_set_idx;
  }
  unsigned int(1) chroma_format_present_flag;
  if (chroma_format_present_flag)
    unsigned int(2) chroma_format_idc;
  else
    bit(2) reserved = ‘11’b;
  unsigned int(1) bit_depth_present_flag;
  if (bit_depth_present_flag)
      unsigned int(3) bit_depth_minus8;
  else
    bit(3) reserved = ‘111’b;
  unsigned int(1) reserved= ‘1’b;
  unsigned int(8) numOfArrays;
  for (j=0; j < numOfArrays; j++) {
    unsigned int(1) array_completeness;
    bit(1) reserved = 0;
    unsigned int(6) NAL_unit_type;
    unsigned int(16) numNalus;
    for (i=0; i< numNalus; i++) {
      unsigned int(16) nalUnitLength;
      bit(8*nalUnitLength) nalUnit;
    }
  }
}
```

In addition, semantics of the syntax of the VVC decoder configuration record may be as shown in the following table.

```
TABLE 6
general_profile_idc, general_tier_flag, general_sub_profile_idc,
  general_constraint_info, general_level_idc,
  ptl_frame_only_constraint_flag, ptl_multilayer_enabled_flag,
  sublayer_level_present, and sublayer_level_idc[i] contain the matching
  values for the fields general_profile_idc, general_tier_flag, general_sub_profile_idc, the
  bits in general_constraint_info( ), general_level_idc, ptl_multilayer_enabled_flag,
  ptl_frame_only_constraint_flag, sublayer_level_present, and sublayer_level_idc[i] as
  defined in ISO/IEC 23090-3, for the stream to which this configuration record applies.
avg FrameRate gives the average frame rate in units of frames/(256 seconds), for the
  stream to which this configuration record applies. Value 0 indicates an unspecified
  average frame rate.
constant FrameRate equal to 1 indicates that the stream to which this configuration
  record applies is of constant frame rate. Value 2 indicates that the representation of
  each temporal layer in the stream is of constant frame rate. Value 0 indicates that the
  stream may or may not be of constant frame rate.
numTemporalLayers greater than 1 indicates that the track to which this configuration
  record applies is temporally scalable and the contained number of temporal layers (also
  referred to as temporal sublayer or sublayer in ISO/IEC 23090-3) is equal to
  numTemporalLayers. Value 1 indicates that the track to which this configuration record
  applies is not temporally scalable. Value 0 indicates that it is unknown whether the
  track to which this configuration record applies is temporally scalable.
lengthSizeMinusOne plus 1 indicates the length in bytes of the NALUnitLength field
  in a VVC video stream sample in the stream to which this configuration record applies.
  For example, a size of one byte is indicated with a value of 0. The value of this field shall
  be one of 0, 1, or 3 corresponding to a length encoded with 1, 2, or 4 bytes, respectively.
ptl_present_flag equal to 1 specifies that the track contains a VVC bitstream
  corresponding to a specific output layer set. ptl_present_flag equal to 0 specifies
  that the track may not contain a VVC bitstream corresponding to a specific output layer
  set, but rather may contain one or more individual layers that do not form an output
  layer set or individual sublayers excluding the sublayer with TemporalId equal to 0.
num_sub_profiles defines the number of sub profiles indicated in the decoder
  configuration record.
track_ptl specifies the profile, tier, and level of the output layer set represented by the
  VVC bitstream contained in the track.
output_layer_set_idx specifies the output layer set index of an output layer set
  represented by the VVC bitstream contained in the track. The value of
  output_layer_set_idx may be used as the value of the TargetOlsIdx variable
  provided by external means to the VVC decoder, as specified in ISO/IEC 23090-3, for
  decoding the bitstream contained in the track.
chroma_format_present_flag equal to 0 specifies that chroma_format_idc is not
  present. chroma_format_present_flag equal to 1 specifies that
  chroma_format_idc is present.
chroma_format_idc indicates the chroma format that applies to this track. The
  following constraints apply for chroma_format_idc:
    - If the value of sps_chroma_format_idc, as defined in ISO/IEC 23090-3, is the
      same in all SPSs referenced by the NAL units of the track,
      chroma_format_idc shall be equal to sps_chroma_format_idc.
    - Otherwise, if ptl_present_flag is equal to 1, chroma_format_idc
      shall be equal to
      vps_ols_dpb_chroma_format[output_layer_set_idx], as
      defined in ISO/IEC 23090-3.
    - Otherwise, chroma_format_idc shall not be present.
bit_depth_present_flag equal to 0 specifies that bit_depth_minus8 is not
  present. bit_depth_present_flag equal to 1 specifies that bit_depth_minus8
  is present.
bit_depth_minus8 indicates the bit depth that applies to this track. The following
  constraints apply for bit_depth_minus8:
    - If the value of sps_bitdepth_minus8, as defined in ISO/IEC 23090-3, is the
      same in all SPSs referenced by the NAL units of the track,
      bit_depth_minus 8 shall be equal to sps_bitdepth_minus8.
    - Otherwise, if ptl_present_flag is equal to 1, bit_depth_minus8
      shall be equal to
      vps_ols_dpb_bitdepth_minus8[ output_laye_set_idx], as
      defined in ISO/IEC 23090-3.
    - Otherwise, bit_depth_minus8 shall not be present.
numArrays indicates the number of arrays of NAL units of the indicated type(s).
array_completeness when equal to 1 indicates that all NAL units of the given type are
  in the following array and none are in the stream; when equal to 0 indicates that
  additional NAL units of the indicated type may be in the stream; the default and
  permitted values are constrained by the sample entry name.
NAL_unit_type indicates the type of the NAL units in the following array (which shall be
  all of that type); it takes a value as defined in ISO/IEC 23090-2; it is restricted to take
  one of the values indicating a DCI, VPS, SPS, PPS, APS, prefix SEI, or suffix SEI NAL unit.
numNalus indicates the number of NAL units of the indicated type included in the
  configuration record for the stream to which this configuration record applies. The SEI
  array shall only contain SEI messages of a ‘declarative’ nature, that is, those that provide
  information about the stream as a whole. An example of such an SEI could be a user-
  data SEI.
nalUnitLength indicates the length in bytes of the NAL unit.
nalUnit contains a DCI, VPS, SPS, PPS, APS or declarative SEI NAL unit, as specified in
  ISO/IEC 23090-3.
```

For example, referring to Table 6, the syntax elements general_profile_idc, general_tier_flag, general_sub_profile_idc, general_constraint_info, general_level_idc, ptl_frame_only_constraint_flag, ptl_multilayer_enabled_flag, sublayer_level_present and sublayer_level_idc[i] may include matching values of fields for a stream to which the VVC decoder configuration record, defined in ISO/IEC 23090-3, applies general_profile_idc, general_tier_flag, general_sub_profile_idc, bits of general_constraint_info( ), general_level_idc, ptl_multilayer_enabled_flag, ptl_frame_only_constraint_flag, sublayer_level_present, and sublayer_level_idc[i]. Here, avgFrameRate may provide an average frame rate of a stream to which the VVC decoder configuration record is applied in units of frames/(256 seconds). A value of 0 may indicate an unspecified average frame rate.

Also, for example, referring to Table 6, the syntax element constantFrameRate may indicate a constant frame rate for the VVC decoder configuration record. For example, constantFrameRate equal to 1 may indicate that a stream to which the VVC decoder configuration record is applied is of a constant frame rate. A constantFrameRate equal to 2 may indicate that the representation of each temporal layer of the stream is of a constant frame rate. A constantFrameRate equal to 0 may indicate that the stream may or may not be of a constant frame rate.

Also, for example, referring to Table 6, the syntax element numTemporalLayers may indicate the number of temporal layers included in a track to which the VVC decoder configuration record is applied. For example, numTemporalLayers greater than 1 may indicate that the track to which the VVC decoder configuration record is applied is temporally scalable and the number of the temporal layers (referred to as temporal sublayers or sublayers in ISO/IEC 23090-3) included in the track is equal to numTemporalLayers. numTemporalLayers equal to 1 may indicate that a track to which the VVC decoder configuration record is applied is not temporally scalable. numTemporalLayers equal to 0 may indicate that it is unknown whether a track to which the VVC decoder configuration record is applied is temporally scalable.

Also, for example, referring to Table 6, the syntax element lengthSizeMinusOne plus 1 may indicate the length in bytes of the NALUnitLength field in the VVC video stream sample of the stream to which this configuration record is applied. For example, a size of one byte may be indicated by with a value of 0. The value of lengthSizeMinusOne may be one of 0, 1, or 3, corresponding to a length encoded as 1, 2, or 4 bytes, respectively.

Also, for example, referring to Table 6, the syntax element ptl_present_flag may indicate that a track includes a VVC bitstream corresponding to a specific output layer set, and thus may indicate whether or not PTL information is included. For example, ptl_present_flag equal to 1 may indicate that the track includes a VVC bitstream corresponding to a specific output layer set (specific OLS). ptl_present_flag equal to 0 may indicate that the track may not include a VVC bitstream corresponding to a specific OLS, but rather may include one or more individual layers that do not form an OLS or individual sublayers excluding the sublayer with TemporalId equal to 0.

Also, for example, referring to Table 6, the syntax element num_sub_profiles may define the number of sub profiles indicated in the VVC decoder configuration record.

Also, for example, referring to Table 6, the syntax element track_ptl may indicate a profile, tier, and level of an OLS indicated by a VVC bitstream included in a track.

Also, for example, referring to Table 6, the syntax element output_layer_set_idx may indicate an output layer set index of an output layer set indicated by a VVC bitstream included in a track. The value of output_layer_set_idx may be used as the value of the TargetOlsIdx variable provided by external means to the VVC decoder, as specified in ISO/IEC 23090-3, to decode the bitstream included in the track.

Also, for example, referring to Table 6, the syntax element chroma_format_present_flag may indicate whether chroma_format_idc is present. For example, chroma_format_present_flag equal to 0 may indicate that chroma_format_idc is not present. chroma_format_present_flag equal to 1 may indicate that chroma_format_idc is present.

Also, for example, referring to Table 6, the syntax element chroma_format_idc may indicate a chroma format applied to the track. For example, the following constraints may be applied to chroma_format_idc.
If the value of sps_chroma_format_idc defined in ISO/IEC 23090-3 is the same in all SPSs referenced by NAL units of a track, chroma_format_idc shall be equal to sps_chroma_format_idc.
Otherwise, if ptl_present_flag is equal to 1, chroma_format_idc shall be equal to vps_ols_dpb_chroma_format[output_layer_set_idx] defined in ISO/IEC 23090-3.
Otherwise (i.e., if the above conditions are not satisfied), chroma_format_idc is not present.

Also, for example, referring to Table 6, the syntax element bit_depth_present_flag may indicate whether bit_depth_minus8 is present. For example, bit_depth_present_flag equal to 0 may indicate that bit_depth_minus8 is not present. bit_depth_present_flag equal to 1 may indicate that bit_depth_minus8 is present.

Also, for example, referring to Table 6, a syntax element bit_depth_minus8 may indicate a bit depth applied to the track. For example, the following constraints may be applied to bit_depth_minus8.
If the value of sps_bitdepth_minus8 defined in ISO/IEC 23090-3 is the same in all SPSs referred to by NAL units of a track, bit_depth_minus8 shall be equal to sps_bitdepth_minus8.
Otherwise, if ptl_present_flag is equal to 1, bit_depth_minus8 shall be equal to vps_ols_dpb_bitdepth_minus8 [output_layer_set_idx] defined in ISO/IEC 23090-3.
Otherwise (i.e., if the above conditions are not satisfied), bit_depth_minus8 is not present.

Also, for example, referring to Table 6, the syntax element numArrays may indicate the number of NAL unit arrays of the indicated type(s).

Also, for example, referring to Table 6, the syntax element array_completeness may indicate whether additional NAL units may be present in the stream. For example, array_completeness equal to 1 may indicate that all NAL units of a given type are in the following array and none are in the stream. Also, for example, array_completeness equal to 0 may indicate that additional NAL units of the indicated type may be in the stream. The default and permitted values may be constrained by the sample entry name.

Also, for example, referring to Table 6, the syntax element NAL_unit type may indicate the type of NAL units in the following array (which shall be all of that type). NAL_unit type may have a value defined in ISO/IEC 23090-2. In addition, NAL unit type may be restricted to have one of values indicating DCI, VPS, SPS, PPS, APS, prefix SEI or suffix SEI NAL unit.

Also, for example, referring to Table 6, the syntax element numNalus may indicate the number of NAL units of an indicated type included in the VVC decoder configuration record for a stream to which the VVC decoder configuration record is applied. An SEI array may include only SEI messages of a ‘declarative’ nature, that is, those that provide information on the stream as a whole. An example of such an SEI may be a user-data SEI.

Also, for example, referring to Table 6, the syntax element nalUnitLength may indicate the length in bytes of the NAL unit.

Also, for example, nalUnit may include DCI, VPS, SPS, PPS, APS or declarative SEI NAL unit specified in ISO/IEC 23090-3.

Meanwhile, in order to reconstruct an access unit from samples of multiple tracks carrying a multi-layer VVC bitstream, an operating point may be determined first. For example, when a VVC bitstream is represented by multiple VVC tracks, a file parser may identify the tracks needed for a chosen operating point as follows.

For example, the file parser may find all tracks with VVC sample entries. If the tracks include an ‘oref’ track reference for the same ID, that ID may be resolved to either a VVC track or an ‘opeg’ entity group. An operating point may be selected from an ‘opeg’ entity group or a ‘vopi’ sample group suitable for decoding capacity and application purposes.

When an ‘opeg’ entity group is present, it may indicate that a set of tracks exactly represents the selected operating point. Thus, a VVC bitstream may be reconstructed from the set of tracks and decoded.

In addition, when an ‘opeg’ entity group is not present (i.e., if a ‘vopi’ sample group is present), it may be discovered from the ‘vopi’ and ‘linf’ sample groups which set of tracks is needed for decoding the selected operating point.

In order to reconstruct a bitstream from multiple VVC tracks carrying a VVC bitstream, the target highest value TemporalId may need to be determined first. When a plurality of tracks include data for an access unit, the alignment of respective samples in the tracks may be performed based on the sample decoding times, that is, using the time-to-sample table without considering edit lists.

When a VVC bitstream is represented by multiple VVC tracks, the decoding times of the samples shall be such that if the tracks were combined into a single stream ordered by increasing the decoding time, the access unit order would be correct as specified in ISO/IEC 23090-3. Meanwhile, a sequence of access units may be reconstructed from respective samples in the required tracks according to the implicit restoration process described below. For example, the implicit reconstruction process of a VVC bitstream may be as follows.

For example, when an Operating Points Information sample group is present, a required track may be selected based on a layer and reference layers carrying as indicated in the operating point information and the layer information sample group.

Also, for example, when an operating point entity group is present, a required track may be selected based on information in OperatingPointGroupBox.

In addition, for example, when reconstructing a bitstream including a sublayer for which the VCL NAL units have TemporalId greater than 0, all lower sublayers (i.e., sublayers for which the VCL NAL units have smaller TemporalId) within the same layer are also included in the resulting bitstream, and the required track may be selected accordingly.

In addition, for example, when reconstructing an access unit, picture units (defined in ISO/IEC 23090-3) from samples having the same decoding time may be placed into the access unit in increasing order of nuh_layer_id value.

In addition, for example, when reconstructing an access unit with dependent layers and max_tid_il_ref_pics_plus1 is greater than 0, sublayers of layers for which the VCL NAL units have TemporalId less than or equal to max_tid_il_ref_pics_plus1−1 (indicated in operating point information sample group) within the same layer are also included in the resulting bitstream and the required track may be selected accordingly.

Also, for example, if a VVC track includes a ‘subp’ track reference, each picture unit may be reconstructed as specified in clause 11.7.3 of ISO/IEC 23090-3 with additional constraints on EOS and EOB NAL units specified below. The process of clause 11.7.3 of ISO/IEC 23090-3 may be repeated for each layer of the target operating point in increasing order of nuh_layer_id. Otherwise, each picture unit may be reconstructed as follows.

Reconstructed access units may be placed into the VVC bitstream in increasing order of decoding time. As described further below, duplicates of end of bitstream (EOB) and end of sequence (EOS) NAL units may be removed from the VVC bitstream.

Also, for example, for access units that are within the same coded video sequence of a VVC bitstream and that belong to different sublayers stored in multiple tracks, there may be one or more tracks including the EOS NAL unit with a particular nuh_layer_id value in the respective samples. In this case, only one of the EOS NAL units may be kept in the last of these access units (the one with the greatest decoding time) in the final reconstructed bitstream, may be placed after all NAL units except for the EOB NAL unit (if present) of the last of these access units, and other EOS NAL units may be discarded. Similarly, there may be one or more tracks including an EOB NAL unit in respective samples. In this case, only one of the EOB NAL units may be kept in the final reconstructed bitstream, may be placed at the end of the last of these access units, and other EOB NAL units may be discarded.

Also, for example, since a specific layer or sublayer may be represented by one or more tracks, when finding out the required track for an operating point, it may have to be selected among the set of tracks that conveys the specific layer or the sublayer altogether.

Further, for example, when the operating point entity group is not present, after selecting among tracks carrying the same layer or sublayer, the final required track may still collectively carry some layers or sublayers that do not belong to the target operation point. A bitstream reconstructed for a target operating point may not include the layers or sublayers that are carried in the final required tracks but do not belong to the target operating point.

In a procedure for reconstructing a picture unit from a sample in a VVC track by referring to VVC subpicture tracks, the sample of the VVC track may be interpreted as an access unit including the next NAL unit in enumeration order.
the AUD NAL unit, when present (and the first NAL unit) in the sample.
when the sample is the first sample of a sequence of samples associated with the same sample entry, the parameter set and SEI NAL units contained in the sample entry, if any.
the NAL units present in the sample up to and including the PH NAL unit.
the content of the time-aligned (in decoding time) resolved sample from each referenced VVC subpicture track in the order specified in the ‘spor’ sample group description entry mapped to this sample, excluding all VPS, DCI, SPS, PPS, AUD, PH, EOS and EOB NAL units, if any. For example, track references may be resolved as specified as follows. When the referenced VVC subpicture track is associated with a VVC non-VCL track, the resolved sample of the VVC subpicture track may contain the non-VCL NAL units, if any, of the time-aligned sample in the VVC non-VCL track.
the NAL units that follow the PH NAL unit in the sample. For example, the NAL units that follow the PH NAL unit in the sample may include suffix SEI NAL units, suffix APS NAL units, an EOS NAL unit, an EOB NAL unit, or reserved NAL units that are allowed after the last VCL NAL unit.

The ‘subp’ track reference indices of the ‘spor’ sample group description entry may be resolved as follows.
If the track reference points to a track ID of a VVC subpicture track, the track reference may be resolved to the VVC subpicture track.
Otherwise (the track reference points to an ‘alte’ track group), the track reference may be resolved to any one of the tracks of the ‘alte’ track group. If a particular track reference index value was resolved to a particular track in the previous sample, it may be resolved in the current sample to either of the following:—the same particular track, or—any other track in the same ‘alte’ track group that contains a sync sample that is time-aligned with the current sample. For example, the VVC subpicture tracks in the same ‘alte’ track group are necessarily independent of any other VVC subpicture tracks referenced by the same VVC base track to avoid decoding mismatches and may therefore be constrained as follows:—all the VVC subpicture tracks contain the VVC subpictures.—the subpicture boundaries are like picture boundaries.—Loop filtering is turned off across subpicture boundaries.

If a reader selects VVC subpicture tracks containing VVC subpictures with a set of subpicture ID values that is the initial selection or differs from the previous selection, the following steps may be taken:
The ‘spor’ sample group description entry may be studied to conclude whether a PPS or SPS NAL units need to be changed. For example, an SPS change may be only possible at the start of a CLVS.
If the ‘spor’ sample group description entry indicates that start code emulation prevention bytes are present before or within the subpicture IDs in the containing NAL unit, an RBSP may be derived from the NAL unit (i.e., start code emulation prevention bytes are removed). After overriding in the next step, start code emulation prevention may be re-done.
The reader may use the bit position and the subpicture ID length information in the ‘spor’ sample group entry to conclude which bits are overwritten to update the subpicture IDs to selected ones.
When the subpicture ID values of a PPS or SPS are initially selected, the reader needs to rewrite the PPS or SPS, respectively, with the selected subpicture ID values in the reconstructed access unit.
When the subpicture ID values of a PPS or SPS are changed compared to the previous PPS or SPS (respectively) with the same PPS ID value or SPS ID value (respectively), the reader needs to include a copy of that previous PPS and SPS (if the PPS or SPS with that same PPS or SPS ID value, respectively, is not present in the access unit) and may rewrite the PPS or SPS (respectively) with the updated subpicture ID value in the reconstructed access unit.

Meanwhile, in the current specification for the carriage of VVC in ISOBMFF, for signalling of operating point information, there is no signalling about the size of picture units resulting from reconstructing the samples based on the operating point. Information on picture size may be needed for file parser when deciding which operating point should be selected to be reconstructed.

Accordingly, the present disclosure proposes a solution to the above problem. The proposed embodiments may be applied individually or in combinations.

In an example of an embodiment according to the present disclosure, for signalling of operating point information, picture size information for pictures reconstructed from each operating point may be present. In another example of the embodiment, only the maximum picture size of an output layer set may be signaled. In another example of the embodiment, the picture size of each output layer may be signaled.

In an example of another embodiment according to the present disclosure, the signaled picture size may be the cropped picture size that specifies the displayed picture size. In another example of the embodiment, the signaled picture size may be the uncropped picture size. In another example of the embodiment, both cropped and uncropped picture size may be present.

For example, as an embodiment according to the present disclosure, an operating point entity group configured as shown in the following table may be proposed.

TABLE 7

```
aligned (8) class OperatingPointGroupBox extends
EntityToGroupBox (‘opeg’,0,0)
{
  unsigned int (8) num_profile_tier_level_minus1;
  for (i=0; i<= num_profile_tier_level_minus1; i++)
    VvcPTLRecord (0) opeg_ptl[i];
  unsigned int(16) num_operating_points;
  for (i=0; i<num_operating_points) {
    unsigned int(16) output_layer_set_idx;
    unsigned int(16) max_width;
    unsigned int(16) max_height;
    unsigned int(8) ptl_idx;
    unsigned int(8) max_temporal_id;
    unsigned int(8) layer_count;
    for (j=0; j<layer_count; j++) {
      unsigned int(6) layer_id;
      unsigned int(1) is_outputlayer;
      bit(1) reserved = 0;
    }
    bit(6) reserved = 0;
    unsigned int(1) frame_rate_info_flag
    unsigned int(1) bit_rate_info_flag
    if (frame_rate_info_flag) {
      unsigned int(16) avgFrameRate;
      bit(6) reserved = 0;
      unsigned int(2) constantFrameRate;
    }
    if (bit_rate_info_flag) {
      unsigned int(32) maxBitRate;
      unsigned int(32) avgBitRate;
    }
    unsigned int(8) entity_count;
    for (j=0; j<entity_count; j++) {
      unsigned int(8) entity_idx;
    }
  }
}
```

In addition, semantics of the syntax of the operating point entity group according to the present disclosure may be as shown in the following table.

```
TABLE 8
num_profile_tier_level_minus1 plus 1 gives the number of following profiles, tier, and level
  combinations as well as the associated fields.
opeg_ptl[i ] specifies the i-th profile, tier, and level structure.
num_operating_points: Gives the number of operating points for which the information follows.
output_layer_set_idx is the index of the output layer set that defines the operating point. The
  mapping between output_layer_set_idx and the layer_id values shall be the same as
  specified by the VPS for an output layer set with index output_layer_set_idx.
max_width and max_height are the maximum visual width and height of the picture
  units reconstructed based on the operating point (or the output layer set), in pixels
ptl_idx: Signals the zero-based index of the listed profile, level, and tier structure for the output
  layer set with index output_layer_set_idx.
max_temporal_id: Gives the maximum TemporalId of NAL units of this operating point.
  NOTE: The maximum TemporalId value indicated in the layer information sample group has different
  semantics from the maximum TemporalId indicated here. However, they may carry the same literal
  numerical values.
layer_count: This field indicates the number of necessary layers, as defined ISO/IEC 23090-3, of
  this operating point.
layer_id: provides the nuh_layer_id values for the layers of the operating point.
is_outputlayer: A flag that indicates if the layer is an output layer or not. A one indicates an
  output layer.
frame_rate_info_flag equal to 0 indicates that no frame rate information is present for the
  operating point. The value 1 indicates that frame rate information is present for the operating
  point.
bit_rate_info_flag equal to 0 indicates that no bitrate information is present for the
  operating point. The value 1 indicates that bitrate information is present for the operating point.
avgFrameRate gives the average frame rate in units of frames/(256 seconds) for the operating
  point. Value 0 indicates an unspecified average frame rate.
constantFrameRate equal to 1 indicates that the stream of the operating point is of constant
  frame rate. Value 2 indicates that the representation of each temporal layer in the stream of the
  operating point is of constant frame rate. Value 0 indicates that the stream of the operating point
  may or may not be of constant frame rate.
maxBitRate gives the maximum bit rate in bits/second of the stream of the operating point, over
  any window of one second.
avgBitRate gives the average bit rate in bits/second of the stream of the operating point.
entity_count specifies the number of tracks that are present in an operating point.
entity_idx specifies the index to the entity_id list in the entity group that belongs to an
  operating point.
```

Referring to Tables 7 and 8, information on the maximum picture width (max width) for the operating point and information of the maximum picture height (max height) for the operating point may be included/configured in the operating point entity group. (it may be signaled in the operating point entity group). The operating point entity group may include information on the number of operating points (num_operating_points), and based on the information on the number of operating points, information on the maximum picture width for each operating point and the information on the maximum picture height for each operating point may be included/constructed in the operating point entity group. As for the information on the picture width and the information on the picture height, signaling in Tables 7 and 8 may also be applied to the operating point information sample group. That is, information on the maximum picture width (max_width) for each operating point and information on the maximum picture height (max height) for each operating point may be included/configured in the operating point information sample group (it may be signaled in the operating point information sample group).

The operating point entity group may include PTL information. Here, for example, the PTL information may include a PTL index (ptl_idx) and/or information on a PTL structure (opeg_ptl[i]). For example, the PTL index (ptl_idx) may indicate a profile, tier, and level structure of an OLS represented by a (VVC) bitstream included in a track. For example, the PTL index may indicate a profile, tier, and level structure of an OLS represented by a bitstream in a track. Also, for example, the information on the PTL structure (opeg_ptl[i]) may indicate an i-th profile, tier, and level structure. The profile, tier and level structure may be referred to as a PTL structure.

Also, for example, as another embodiment according to the present disclosure, an operating point entity group configured as shown in the following table may be proposed.

TABLE 9

```
aligned(8) class OperatingPointGroupBox extends
EntityToGroupBox (‘opeg’,0,0)
{
  unsigned int(8) num_profile_tier_level_minus1;
  for (i=0; i<=num_profile_tier_level_minus1; i++)
    VvcPTLRecord(0) opeg_ptl[i];
  unsigned int(16) num_operating_points;
  for (i=0; i<num_operating_points) {
    unsigned int(16) output_layer_set_idx;
    unsigned int(8) ptl_idx;
    unsigned int(8) max_temporal_id;
    unsigned int(8) layer_count;
    for (j=0; j<layer_count; j++) {
      unsigned int(6) layer_id;
      unsigned int(1) is_outputlayer;
      bit(1) reserved = 0;
      if (is_outputlayer) {
        unsigned int(16) pic_width;
        unsigned int(16) pic_height;
      }
    }
    bit(6) reserved = 0;
    unsigned int(1) frame_rate_info_flag
    unsigned int(1) bit_rate_info_flag
    if (frame_rate_info_flag) {
      unsigned int(16) avgFrameRate;
      bit(6) reserved = 0;
      unsigned int(2) constantFrameRate;
    }
    if (bit_rate_info_flag) {
      unsigned int(32) maxBitRate;
      unsigned int(32) avgBitRate;
    }
    unsigned int(8) entity_count;
    for (j=0; j<entity_count; j++) {
      unsigned int(8) entity_idx;
    }
  }
}
```

In addition, semantics of the syntax of the operating point entity group according to the present embodiment may be as shown in the following table.

```
TABLE 10
num_profile_tier_level_minus1 plus 1 gives the number of following profiles, tier, and level
  combinations as well as the associated fields.
opeg_ptl[i] specifies the i-th profile, tier, and level structure.
num_operating_points: Gives the number of operating points for which the information follows.
output_layer_set_idx is the index of the output layer set that defines the operating point. The
  mapping between output_layer_set_idx and the layer_id values shall be the same as
  specified by the VPS for an output layer set with index output_layer_set_idx.
ptl_idx: Signals the zero-based index of the listed profile, level, and tier structure for the output
  layer set with index output_layer_set_idx.
max_temporal_id: Gives the maximum TemporalId of NAL units of this operating point.
  NOTE: The maximum TemporalId value indicated in the layer information sample group has different
  semantics from the maximum TemporalId indicated here. However, they may carry the same literal
  numerical values.
layer_count: This field indicates the number of necessary layers, as defined ISO/IEC 23090-3, of
  this operating point.
layer_id: provides the nuh_layer_id values for the layers of the operating point.
is_outputlayer: A flag that indicates if the layer is an output layer or not. A one indicates an
  output layer.
pic_width and pic_height are the visual width and height of the picture units
  reconstructed based on the operating point (or the output layer set), in pixels
frame_rate_info_flag equal to 0 indicates that no frame rate information is present for the
  operating point. The value 1 indicates that frame rate information is present for the operating
  point.
bit_rate_info_flag equal to 0 indicates that no bitrate information is present for the
  operating point. The value 1 indicates that bitrate information is present for the operating point.
avgFrameRate gives the average frame rate in units of frames/(256 seconds) for the operating
  point. Value 0 indicates an unspecified average frame rate.
constantFrameRate equal to 1 indicates that the stream of the operating point is of constant
  frame rate. Value 2 indicates that the representation of each temporal layer in the stream of the
  operating point is of constant frame rate. Value 0 indicates that the stream of the operating point
  may or may not be of constant frame rate.
maxBitRate gives the maximum bit rate in bits/second of the stream of the operating point, over
  any window of one second.
avgBitRate gives the average bit rate in bits/second of the stream of the operating point.
entity_count specifies the number of tracks that are present in an operating point.
entity_idx specifies the index to the entity_id list in the entity group that belongs to an
  operating point.
```

Referring to Tables 9 and 10, information on the picture width (pic_width) for the operating point and information on the picture height (pic_height) for the operating point may be included/configured in the operating point entity group. (it may be signaled in the operating point entity group). The operating point entity group may include information on the number of operating points (num_operating_points), and based on the information on the number of operating points, information on the picture width for each operating point and information on the picture height for each operating point may be included/constructed in the operating point entity group. As for the information on the picture width and the information on the picture height, the signaling in Tables 9 and 10 may also be applied to the operating point information sample group. That is, information on the picture width (pic_width) for each operating point and information on the picture height (pic_height) for each operating point may be included/configured in the operating point information sample group (it may be signaled in the operating point information sample group).

The operating point entity group may include PTL information. Here, for example, the PTL information may include a PTL index (ptl_idx) and/or information on a PTL structure (opeg_ptl[i]). For example, the PTL index (ptl_idx) may indicate a profile, tier, and level structure of an OLS represented by a (VVC) bitstream included in a track. For example, the PTL index may indicate a profile, tier, and level structure of an OLS represented by a bitstream in a track. Also, for example, the information on the PTL structure (opeg_ptl[i]) may indicate an i-th profile, tier, and level structure. The profile, tier and level structure may be referred to as a PTL structure.

According to the embodiments of the present disclosure, a picture size for each output layer set is provided, and it may be used as one of the aspects to be considered when selecting an operating point.

According to the embodiments of the present disclosure, it is possible to select an operating point suitable for the size of an output picture, and accordingly, the accuracy of picture reconstruction may be increased and the subjective/objective quality of a reconstructed picture may be improved.

FIG. 4 briefly illustrates a method of generating a media file according to an embodiment of the present disclosure. The method disclosed in FIG. 4 may be performed by a media file generating apparatus disclosed in FIG. 7. The media file generating apparatus may generate a media file including video information. Specifically, for example, the image processor of the media file generating apparatus of FIG. 7 may perform S400 and S410 of FIG. 4, and the media file generator of the media file generating apparatus of FIG. 7 may perform S420 of FIG. 4. also, although not shown, a process of encoding a bitstream including image information may be performed by an encoder of the media file generating apparatus.

The media file generating apparatus may store video information in tracks of a file format (S400). Here, the video information may include network abstraction layer (NAL) units. NAL units may include VCL NAL units and/or non-VCL NAL units.

The media file generating apparatus may configure information related to an operating point in the file format (S410). An operating point may be related to an output layer set, the maximum TemporalId value, and profile/level/tier signaling. Layer-related information of an encoded bitstream may be determined based on the operating point.

The media file generating apparatus may generate a media file based on the file format (S420). The media file may include sample entries and tracks. Also, the media file may include various records such as a decoder configuration record, for example, the NAL units may be included in a decoder configuration record.

In one example, the file format may include information on the maximum picture width for the operating point and information on the maximum picture height for the operating point. Information on the maximum picture width and information on the maximum picture height may be used to select the operating point.

In an example, the media file generating apparatus may configure an operating point entity group within the file format, and/or an operating point information sample group within the file format. For example, the information on the maximum picture width for the operating point and the information on the maximum picture height for the operating point may be configured in the operating point entity group and/or the operating point information sample group. This example may be explained based on Tables 7 and 8.

In an example, the operating point entity group and/or the operating point information sample group may include information on the number of operating points. Based on the number of the operating points, information on operating points may be configured in the operating point entity group and/or the operating point information sample group.

In one example, the operating point entity group may include information on the mapping of the operating points to the tracks. For example, multiple tracks may be mapped to one operating point, or one track may be mapped to multiple operating points. A mapping relationship between tracks and operating points may be related to a layer for coding (including an output layer).

In one example, the operating point entity group and/or the operating point information sample group may include flag information indicating whether frame rate related information is present for the operating point. Based on the flag information equal to 1, the operating point entity group and/or the operating point information sample group may include information on an average frame rate for the operating point and information on a constant frame rate for the operating point. For example, the syntax element of the information on the average frame rate may be avgFrameRate, and the syntax element of the information on the constant frame rate may be constantFrameRate.

For example, the information on the average frame rate may indicate the average frame rate for the operating point (in units of frames/(256 seconds)). A value of 0 may indicate an unspecified average frame rate. That is, when the value of the information on the average frame rate is 0, the information on the average frame rate may indicate an unspecified average frame rate.

Also, for example, the information on the constant frame rate may indicate a constant frame rate for the operating point. For example, the information on the constant frame rate may indicate whether or not the constant frame rate is used. For example, a value of the information on the constant frame rate is 1, the information on the constant frame rate may indicate that the stream of the operating point is of a constant frame rate. Also, for example, a value of the information on the constant frame rate is 2, the information on the constant frame rate may indicate that the representation of each temporal layer in the stream is of a constant frame rate. Also, for example, a value of the information on the constant frame rate is 0, the information on the constant frame rate may indicate that the stream may or may not be of a constant frame rate.

In one example, the operating point entity group may include information on the number of tracks present in the operating point. The operating point entity group may include information on an index related to ID values of the tracks present in the operating point. For example, the information on the index may indicate an index to an entity ID list in an entity group belonging to the operating point.

In one example, the operating point may be associated with an output layer set (OLS). The operating point entity group and/or the operating point information sample group may include information on an index of the output layer set.

Here, for example, the OLS index may indicate an OLS index of an OLS represented by a (VVC) bitstream included in a track. That is, the OLS index may indicate an OLS represented by a VVC bitstream included in a track. The value of the OLS index may be used as a value of a target OLS index to decode a bitstream included in a track. The syntax element of the OLS index may be the aforementioned output_layer_set_idx.

FIG. 5 briefly illustrates a method of generating a media file according to another embodiment of the present disclosure. The method disclosed in FIG. 5 may be performed by the media file generating apparatus disclosed in FIG. 7. The media file generating apparatus may generate a media file including video information. Specifically, for example, the image processor of the media file generating apparatus of FIG. 7 may perform S500 and S510 of FIG. 5, and the media file generator of the media file generating apparatus of FIG. 7 may perform S520 of FIG. 5. Although not shown, a process of encoding a bitstream including image information may be performed by an encoder of the media file generating apparatus.

The media file generating apparatus may store video information in tracks of a file format (S500). Here, the video information may include network abstraction layer (NAL) units. NAL units may include VCL NAL units and/or non-VCL NAL units.

The media file generating apparatus may configure an operating point entity group including information related to an operating point in the file format (S510). An operating point may be related to an output layer set, the maximum TemporalId value, and profile/level/tier signaling. Layer-related information of an encoded bitstream may be determined based on the operating point.

The media file generating apparatus may generate a media file based on the file format (S520). The media file may contain sample entries and tracks. Also, the media file may include various records such as a decoder configuration record, for example, the NAL units may be included in a decoder configuration record.

In one example, the operating point entity group may include information on a maximum picture width for the operating point and information on a maximum picture height for the operating point. This example may be explained based on Tables 7 and 8. Information on the maximum picture width and information on the maximum picture height may be used to select the operating point.

In one example, the operating point entity group may include information on the number of operating points. Based on the number of the operating points, information on operating points may be configured in the operating point entity group.

In one example, the operating point entity group may include information on the mapping of the operating points to the tracks. For example, multiple tracks may be mapped to one operating point, or one track may be mapped to multiple operating points. A mapping relationship between tracks and operating points may be related to a layer for coding (including an output layer).

In one example, the operating point entity group may include flag information indicating whether frame rate related information is present for the operating point. Based on the flag information equal to 1, the operating point entity group may include information on an average frame rate for the operating point and information on a constant frame rate for the operating point. For example, the syntax element of the information on the average frame rate may be avgFrameRate, and the syntax element of the information on the constant frame rate may be constantFrameRate.

For example, the information on the average frame rate may indicate the average frame rate for the operating point (in units of frames/(256 seconds)). A value of 0 may indicate an unspecified average frame rate. That is, when the value of the information on the average frame rate is 0, the information on the average frame rate may indicate an unspecified average frame rate.

Also, for example, the information on the constant frame rate may indicate a constant frame rate for the operating point. For example, the information on the constant frame rate may indicate whether or not the constant frame rate is used. For example, a value of the information on the constant frame rate is 1, the information on the constant frame rate may indicate that the stream of the operating point is of a constant frame rate. Also, for example, a value of the information on the constant frame rate is 2, the information on the constant frame rate may indicate that the representation of each temporal layer in the stream is of a constant frame rate. Also, for example, a value of the information on the constant frame rate is 0, the information on the constant frame rate may indicate that the stream may or may not be of a constant frame rate.

In one example, the operating point entity group may include information on the number of tracks present in the operating point. The operating point entity group may include information on an index related to ID values of the tracks present in the operating point. For example, the information on the index may indicate an index to an entity ID list in an entity group belonging to the operating point.

In one example, the operating point may be associated with an output layer set (OLS). The operating point entity group may include information on the index of the output layer set.

Here, for example, the OLS index may indicate an OLS index of an OLS represented by a (VVC) bitstream included in a track. That is, the OLS index may indicate an OLS represented by a VVC bitstream included in a track. The value of the OLS index may be used as a value of a target OLS index to decode a bitstream included in a track. The syntax element of the OLS index may be the aforementioned output_layer_set_idx.

FIG. 6 briefly illustrates a method of generating a media file according to another embodiment of the present disclosure. The method disclosed in FIG. 6 may be performed by the media file generating apparatus disclosed in FIG. 7. The media file generating apparatus may generate a media file including video information. Specifically, for example, the image processor of the media file generating apparatus of FIG. 7 may perform S600 and S610 of FIG. 6, and the media file generator of the media file generating apparatus of FIG. 7 may perform S620 of FIG. 6. Although not shown, a process of encoding a bitstream including image information may be performed by an encoder of the media file generating apparatus.

The media file generating apparatus may store video information in tracks of a file format (S600). Here, the video information may include network abstraction layer (NAL) units. NAL units may include VCL NAL units and/or non-VCL NAL units.

The media file generating apparatus may configure an operating point information sample group including information related to an operating point in the file format (S510). An operating point may be related to an output layer set, the maximum TemporalId value, and profile/level/tier signaling. Layer-related information of an encoded bitstream may be determined based on the operating point.

The media file generating apparatus may generate a media file based on the file format (S620). The media file may contain sample entries and tracks. Also, a media file may include various records such as a decoder configuration record, for example, the NAL units may be included in a decoder configuration record.

In one example, the operating point information sample group may include information on a maximum picture width for the operating point and information on a maximum picture height for the operating point. Information on the maximum picture width and information on the maximum picture height may be used to select the operating point.

In one example, the operating point information sample group may include information on the number of operating points. Based on the number of the operating points, information on operating points may be configured in the operating point information sample group.

In one example, the operating point information sample group may include flag information indicating whether frame rate related information is present for the operating point. Based on the flag information equal to 1, the operating point information sample group may include information on an average frame rate for the operating point and information on a constant frame rate for the operating point. For example, the syntax element of the information on the average frame rate may be avgFrameRate, and the syntax element of the information on the constant frame rate may be constantFrameRate.

For example, the information on the average frame rate may indicate the average frame rate for the operating point (in units of frames/(256 seconds)). A value of 0 may indicate an unspecified average frame rate. That is, when the value of the information on the average frame rate is 0, the information on the average frame rate may indicate an unspecified average frame rate.

Also, for example, the information on the constant frame rate may indicate a constant frame rate for the operating point. For example, the information on the constant frame rate may indicate whether or not the constant frame rate is used. For example, a value of the information on the constant frame rate is 1, the information on the constant frame rate may indicate that the stream of the operating point is of a constant frame rate. Also, for example, a value of the information on the constant frame rate is 2, the information on the constant frame rate may indicate that the representation of each temporal layer in the stream is of a constant frame rate. Also, for example, a value of the information on the constant frame rate is 0, the information on the constant frame rate may indicate that the stream may or may not be of a constant frame rate.

In one example, the operating point may be associated with an output layer set (OLS). The operating point information sample group may include information on the index of the output layer set.

Here, for example, the OLS index may indicate an OLS index of an OLS represented by a (VVC) bitstream included in a track. That is, the OLS index may indicate an OLS represented by a VVC bitstream included in a track. The value of the OLS index may be used as a value of a target OLS index to decode a bitstream included in a track. The syntax element of the OLS index may be the aforementioned output_layer_set_idx.

FIG. 7 briefly illustrates a media file generating apparatus according to the present disclosure. The method disclosed in FIG. 4, 5 or 6 may be performed by the media file generating apparatus disclosed in FIG. 7. Specifically, for example, the image processor of the media file generating apparatus of FIG. 7 may perform S400 and S410 of FIG. 4, S500 and S510 of FIG. 5, or S600 and S610 of FIG. 6. The media file generator of the media file generating apparatus may perform S420 of FIG. 4, S520 of FIG. 5, or S620 of FIG. 6. Also, although not shown, a process of encoding a bitstream including image information may be performed by an encoder of the media file generating apparatus.

Meanwhile, although not shown, the media file generating apparatus may store the generated media file in a (digital) storage medium or transmit the generated media file to a media file processing apparatus through a network or a (digital) storage medium. Here, the network may include a broadcasting network and/or a communication network, and the digital storage medium may include various storage media such as USB, SD, CD, DVD, Blu-ray, HDD, and SSD.

FIG. 8 briefly illustrates a method of processing a media file according to an embodiment of the present disclosure. The method disclosed in FIG. 8 may be performed by the media file processing apparatus disclosed in FIG. 11. Specifically, for example, the receiver of the media file processing apparatus of FIG. 11 may perform the step of obtaining the media file processed in the method of FIG. 8, and the media file processor of the media file processing apparatus of FIG. 11 may perform S800 to S820 of FIG. 8.

A media file processing apparatus obtains a media file including a decoder configuration record. For example, the media file processing apparatus may obtain the media file through a network or a (digital) storage medium. Here, the network may include a broadcasting network and/or a communication network, and the digital storage medium may include various storage media such as USB, SD, CD, DVD, Blu-ray, HDD, and SSD. The media file may contain sample entries and tracks. Also, a media file may include various records such as a decoder configuration record, for example, the NAL units may be included in a decoder configuration record.

The media file processing apparatus may derive a file format from the media file (S800). The file format may include information related to an operating point.

The media file processing apparatus may select an operating point based on the file format (S810). An operating point may be related to an output layer set, the maximum TemporalId value, and profile/level/tier signaling. Layer-related information of an encoded bitstream may be determined based on the operating point.

The media file processing apparatus may reconstruct video information based on the operating point (S820). The video information may be a bitstream including NAL units. The NAL units may include VCL NAL units and/or non-VCL NAL units. The video information may include tracks selected based on layers (or reference layers) indicated by information on the operating point.

In one example, the file format may include information on the maximum picture width for the operating point and information on the maximum picture height for the operating point. Information on the maximum picture width and information on the maximum picture height may be used to select the operating point.

In one example, the media file processing apparatus may derive an operating point entity group based on the file format, and/or an operating point information sample group based on the file format. For example, the information on the maximum picture width for the operating point and the information on the maximum picture height for the operating point may be configured in the operating point entity group and/or the operating point information sample group. This example may be explained based on Tables 7 and 8.

In an example, the operating point entity group and/or the operating point information sample group may include information on the number of operating points. Based on the number of the operating points, information on operating points may be configured in the operating point entity group and/or the operating point information sample group.

In one example, the operating point entity group may include information on the mapping of the operating points to the tracks. For example, multiple tracks may be mapped to one operating point, or one track may be mapped to multiple operating points. A mapping relationship between tracks and operating points may be related to a layer for coding (including an output layer).

In one example, the operating point entity group and/or the operating point information sample group may include flag information indicating whether frame rate related information is present for the operating point. Based on the flag information equal to 1, the operating point entity group and/or the operating point information sample group may include information on an average frame rate for the operating point and information on a constant frame rate for the operating point. For example, the syntax element of the information on the average frame rate may be avgFrameRate, and the syntax element of the information on the constant frame rate may be constantFrameRate.

For example, the information on the average frame rate may indicate the average frame rate for the operating point (in units of frames/(256 seconds)). A value of 0 may indicate an unspecified average frame rate. That is, when the value of the information on the average frame rate is 0, the information on the average frame rate may indicate an unspecified average frame rate.

Also, for example, the information on the constant frame rate may indicate a constant frame rate for the operating point. For example, the information on the constant frame rate may indicate whether or not the constant frame rate is used. For example, a value of the information on the constant frame rate is 1, the information on the constant frame rate may indicate that the stream of the operating point is of a constant frame rate. Also, for example, a value of the information on the constant frame rate is 2, the information on the constant frame rate may indicate that the representation of each temporal layer in the stream is of a constant frame rate. Also, for example, a value of the information on the constant frame rate is 0, the information on the constant frame rate may indicate that the stream may or may not be of a constant frame rate.

In one example, the operating point entity group may include information on the number of tracks present in the operating point. The operating point entity group may include information on an index related to ID values of the tracks present in the operating point. For example, the information on the index may indicate an index to an entity ID list in an entity group belonging to the operating point.

In one example, the operating point may be associated with an output layer set (OLS). The operating point entity group and/or the operating point information sample group may include information on an index of the output layer set.

Here, for example, the OLS index may indicate an OLS index of an OLS represented by a (VVC) bitstream included in a track. That is, the OLS index may indicate an OLS represented by a VVC bitstream included in a track. The value of the OLS index may be used as a value of a target OLS index to decode a bitstream included in a track. The syntax element of the OLS index may be the aforementioned output_layer_set_idx.

FIG. 9 briefly illustrates a method of processing a media file according to another embodiment of the present disclosure. The method disclosed in FIG. 9 may be performed by the media file processing apparatus disclosed in FIG. 11. Specifically, for example, the receiver of the media file processing apparatus of FIG. 11 may perform the step of obtaining the media file processed in the method of FIG. 9, and the media file processor of the media file processing apparatus of FIG. 11 may perform S900 to S920 of FIG. 9.

A media file processing apparatus obtains a media file including a decoder configuration record. For example, the media file processing apparatus may obtain the media file through a network or a (digital) storage medium. Here, the network may include a broadcasting network and/or a communication network, and the digital storage medium may include various storage media such as USB, SD, CD, DVD, Blu-ray, HDD, and SSD. The media file may contain sample entries and tracks. Also, a media file may include various records such as a decoder configuration record, for example, the NAL units may be included in a decoder configuration record.

The media file processing apparatus may derive an operating point entity group from the media file (S900). In one example, the operating point entity group may include information on the mapping of the operating points to the tracks. For example, multiple tracks may be mapped to one operating point, or one track may be mapped to multiple operating points. A mapping relationship between tracks and operating points may be related to a layer for coding (including an output layer).

The media file processing apparatus may select an operating point based on the operating point entity group (S910). An operating point may be related to an output layer set, the maximum TemporalId value, and profile/level/tier signaling. Layer-related information of an encoded bitstream may be determined based on the operating point.

The media file processing device may reconstruct video information based on the operating point (S920). The video information may be a bitstream including NAL units. The NAL units may include VCL NAL units and/or non-VCL NAL units. The video information may include tracks selected based on layers (or reference layers) indicated by the information on the operating point.

In one example, the operating point entity group may include information on a maximum picture width for the operating point and information on a maximum picture height for the operating point. This example may be explained based on Tables 7 and 8. Information on the maximum picture width and information on the maximum picture height may be used to select the operating point.

In one example, the operating point entity group may include information on the number of operating points. Based on the number of the operating points, information on operating points may be configured in the operating point entity group.

In one example, the operating point entity group may include flag information indicating whether frame rate related information is present for the operating point. Based on the flag information equal to 1, the operating point entity group may include information on an average frame rate for the operating point and information on a constant frame rate for the operating point. For example, the syntax element of the information on the average frame rate may be avgFrameRate, and the syntax element of the information on the constant frame rate may be constantFrameRate.

For example, the information on the average frame rate may indicate the average frame rate for the operating point (in units of frames/(256 seconds)). A value of 0 may indicate an unspecified average frame rate. That is, when the value of the information on the average frame rate is 0, the information on the average frame rate may indicate an unspecified average frame rate.

Also, for example, the information on the constant frame rate may indicate a constant frame rate for the operating point. For example, the information on the constant frame rate may indicate whether or not the constant frame rate is used. For example, a value of the information on the constant frame rate is 1, the information on the constant frame rate may indicate that the stream of the operating point is of a constant frame rate. Also, for example, a value of the information on the constant frame rate is 2, the information on the constant frame rate may indicate that the representation of each temporal layer in the stream is of a constant frame rate. Also, for example, a value of the information on the constant frame rate is 0, the information on the constant frame rate may indicate that the stream may or may not be of a constant frame rate.

In one example, the operating point entity group may include information on the number of tracks present in the operating point. The operating point entity group may include information on an index related to ID values of the tracks present in the operating point. For example, the information on the index may indicate an index to an entity ID list in an entity group belonging to the operating point.

In one example, the operating point may be associated with an output layer set (OLS). The operating point entity group may include information on the index of the output layer set.

Here, for example, the OLS index may indicate an OLS index of an OLS represented by a (VVC) bitstream included in a track. That is, the OLS index may indicate an OLS represented by a VVC bitstream included in a track. The value of the OLS index may be used as a value of a target OLS index to decode a bitstream included in a track. The syntax element of the OLS index may be the aforementioned output_layer_set_idx.

FIG. 10 briefly illustrates a method of processing a media file according to another embodiment of the present disclosure. The method disclosed in FIG. 10 may be performed by the media file processing apparatus disclosed in FIG. 11. Specifically, for example, the receiver of the media file processing apparatus of FIG. 11 may perform the step of obtaining the media file processed in the method of FIG. 10, and the media file processor of the media file processing apparatus of FIG. 11 may perform S1000 to S1020 of FIG. 10.

A media file processing apparatus obtains a media file including a decoder configuration record. For example, the media file processing apparatus may obtain the media file through a network or a (digital) storage medium. Here, the network may include a broadcasting network and/or a communication network, and the digital storage medium may include various storage media such as USB, SD, CD, DVD, Blu-ray, HDD, and SSD. The media file may contain sample entries and tracks. Also, a media file may include various records such as a decoder configuration record, for example, the NAL units may be included in a decoder configuration record.

The media file processing apparatus may derive an operating point information sample group from the media file (S1000). The operating point information sample group may include information related to the operating point. There may be only one track carrying the operating point information sample group. The remaining tracks may refer to a track carrying the operating point information sample group.

The media file processing apparatus may select an operating point based on the operating point information sample group (S1010). An operating point may be related to an output layer set, the maximum TemporalId value, and profile/level/tier signaling. Layer-related information of an encoded bitstream may be determined based on the operating point.

The media file processing apparatus may reconstruct video information based on the operating point (S1020). The video information may be a bitstream including NAL units. The NAL units may include VCL NAL units and/or non-VCL NAL units. The video information may include tracks selected based on layers (or reference layers) indicated by the information on the operating point.

In one example, the operating point information sample group may include information on a maximum picture width for the operating point and information on a maximum picture height for the operating point. Information on the maximum picture width and information on the maximum picture height may be used to select the operating point.

In one example, the operating point information sample group may include information on the number of operating points. Based on the number of the operating points, information on operating points may be configured in the operating point information sample group.

In one example, the operating point information sample group may include flag information indicating whether frame rate related information is present for the operating point. Based on the flag information equal to 1, the operating point information sample group may include information on an average frame rate for the operating point and information on a constant frame rate for the operating point. For example, the syntax element of the information on the average frame rate may be avgFrameRate, and the syntax element of the information on the constant frame rate may be constantFrameRate.

For example, the information on the average frame rate may indicate the average frame rate for the operating point (in units of frames/(256 seconds)). A value of 0 may indicate an unspecified average frame rate. That is, when the value of the information on the average frame rate is 0, the information on the average frame rate may indicate an unspecified average frame rate.

Also, for example, the information on the constant frame rate may indicate a constant frame rate for the operating point. For example, the information on the constant frame rate may indicate whether or not the constant frame rate is used. For example, a value of the information on the constant frame rate is 1, the information on the constant frame rate may indicate that the stream of the operating point is of a constant frame rate. Also, for example, a value of the information on the constant frame rate is 2, the information on the constant frame rate may indicate that the representation of each temporal layer in the stream is of a constant frame rate. Also, for example, a value of the information on the constant frame rate is 0, the information on the constant frame rate may indicate that the stream may or may not be of a constant frame rate.

In one example, the operating point may be associated with an output layer set (OLS). The operating point information sample group may include information on the index of the output layer set.

Here, for example, the OLS index may indicate an OLS index of an OLS represented by a (VVC) bitstream included in a track. That is, the OLS index may indicate an OLS represented by a VVC bitstream included in a track. The value of the OLS index may be used as a value of a target OLS index to decode a bitstream included in a track. The syntax element of the OLS index may be the aforementioned output_layer_set_idx.

FIG. 11 briefly illustrates an apparatus of processing a media file according to the present disclosure. The method disclosed in FIG. 8, FIG. 9, or FIG. 10 may be performed by the media file processing apparatus disclosed in FIG. 11. Specifically, for example, the receiver of the media file processing apparatus of FIG. 11 may perform the step of obtaining the media file processed in the method of FIG. 8, 9 or 10, and the media file processor of the media file processing apparatus of FIG. 11 may perform S800 to S820 of FIG. 8, S900 to S920 of FIG. 9, or S1000 to S1020 of FIG. 10. Meanwhile, although not shown, the media file processing apparatus may include a decoder, and the decoder may decode a bitstream based on the operating point information sample group or the operating point information sample group.

In the above-described embodiment, the methods are described based on the flowchart having a series of steps or blocks. The present disclosure is not limited to the order of the above steps or blocks. Some steps or blocks may occur simultaneously or in a different order from other steps or blocks as described above. Further, those skilled in the art will understand that the steps shown in the above flowchart are not exclusive, that further steps may be included, or that one or more steps in the flowchart may be deleted without affecting the scope of the present disclosure.

The embodiments described in this specification may be performed by being implemented on a processor, a microprocessor, a controller or a chip. For example, the functional units shown in each drawing may be performed by being implemented on a computer, a processor, a microprocessor, a controller or a chip. In this case, information for implementation (e.g., information on instructions) or algorithm may be stored in a digital storage medium.

In addition, the apparatus to which the present disclosure is applied may be included in a multimedia broadcasting transmission/reception apparatus, a mobile communication terminal, a home cinema video apparatus, a digital cinema video apparatus, a surveillance camera, a video chatting apparatus, a real-time communication apparatus such as video communication, a mobile streaming apparatus, a storage medium, a camcorder, a VoD service providing apparatus, an Over the top (OTT) video apparatus, an Internet streaming service providing apparatus, a three-dimensional (3D) video apparatus, a teleconference video apparatus, a transportation user equipment (e.g., vehicle user equipment, an airplane user equipment, a ship user equipment, etc.) and a medical video apparatus and may be used to process video signals and data signals. For example, the Over the top (OTT) video apparatus may include a game console, a blue-ray player, an internet access TV, a home theater system, a smart phone, a tablet PC, a Digital Video Recorder (DVR), and the like.

Furthermore, the processing method to which the present disclosure is applied may be produced in the form of a program that is to be executed by a computer and may be stored in a computer-readable recording medium. Multimedia data having a data structure according to the present disclosure may also be stored in computer-readable recording media. The computer-readable recording media include all types of storage devices in which data readable by a computer system is stored. The computer-readable recording media may include a BD, a Universal Serial Bus (USB), ROM, PROM, EPROM, EEPROM, RAM, CD-ROM, a magnetic tape, a floppy disk, and an optical data storage device, for example. Furthermore, the computer-readable recording media includes media implemented in the form of carrier waves (e.g., transmission through the Internet). In addition, a bit stream generated by the encoding method may be stored in a computer-readable recording medium or may be transmitted over wired/wireless communication networks.

In addition, the embodiments of the present disclosure may be implemented with a computer program product according to program codes, and the program codes may be performed in a computer by the embodiments of the present disclosure. The program codes may be stored on a carrier which is readable by a computer.

FIG. 12 illustrates a structural diagram of a contents streaming system to which the present disclosure is applied.

The content streaming system to which the embodiment(s) of the present disclosure is applied may largely include an encoding server, a streaming server, a web server, a media storage, a user device, and a multimedia input device.

The encoding server compresses content input from multimedia input devices such as a smartphone, a camera, a camcorder, etc. Into digital data to generate a bitstream and transmit the bitstream to the streaming server. As another example, when the multimedia input devices such as smartphones, cameras, camcorders, etc. directly generate a bitstream, the encoding server may be omitted.

The bitstream may be generated by an encoding method or a bitstream generating method to which the embodiment(s) of the present disclosure is applied, and the streaming server may temporarily store the bitstream in the process of transmitting or receiving the bitstream.

The streaming server transmits the multimedia data to the user device based on a user's request through the web server, and the web server serves as a medium for informing the user of a service. When the user requests a desired service from the web server, the web server delivers it to a streaming server, and the streaming server transmits multimedia data to the user. In this case, the content streaming system may include a separate control server. In this case, the control server serves to control a command/response between devices in the content streaming system.

The streaming server may receive content from a media storage and/or an encoding server. For example, when the content is received from the encoding server, the content may be received in real time. In this case, in order to provide a smooth streaming service, the streaming server may store the bitstream for a predetermined time.

Examples of the user device may include a mobile phone, a smartphone, a laptop computer, a digital broadcasting terminal, a personal digital assistant (PDA), a portable multimedia player (PMP), navigation, a slate PC, tablet PCs, ultrabooks, wearable devices (ex. Smartwatches, smart glasses, head mounted displays), digital TVs, desktops computer, digital signage, and the like. Each server in the content streaming system may be operated as a distributed server, in which case data received from each server may be distributed.

The claims described in the present disclosure may be combined in various ways. For example, the technical features of the method claims of the present disclosure may be combined to be implemented as an apparatus, and the technical features of the apparatus claims of the present disclosure may be combined to be implemented as a method. In addition, the technical features of the method claim of the present disclosure and the technical features of the apparatus claim may be combined to be implemented as an apparatus, and the technical features of the method claim of the present disclosure and the technical features of the apparatus claim may be combined to be implemented as a method.

1. A method for generating a media file including video information, comprising:
storing the video information in tracks of a file format;
configuring information related to an operating point in the file format; and
generating the media file based on the file format,
wherein the file format includes information on a maximum picture width for the operating point and information on a maximum picture height for the operating point, and
wherein the information on the maximum picture width and the information on the maximum picture height are used to select the operating point.

2. The method of claim 1, further comprising:
configuring an operating point entity group in the file format; and
configuring an operating point information sample group in the file format,
wherein the information on the maximum picture width for the operating point and the information on the maximum picture height for the operating point are configured in the operating point entity group or the operating point information sample group.

3. The method of claim 2, wherein the operating point entity group includes information on a number of operating points.

4. The method of claim 3, wherein the operating point entity group includes information on a mapping of the operating points and the tracks.

5. The method of claim 3, wherein the operating point entity group includes flag information indicating whether frame rate related information is present for the operating point, and
wherein, in response to the flag information being equal to 1, the operating point entity group includes information on an average frame rate for the operating point and information on a constant frame rate for the operating point.

6. The method of claim 2, wherein the operating point entity group includes information on a number of tracks present in the operating point.

7. The method of claim 6, wherein the operating point entity group includes information on an index related to ID values of the tracks present in the operating point.

8. The method of claim 7, wherein the information on the index indicates an index to an entity ID list in an entity group belonging to the operating point.

9. The method of claim 2, wherein the operating point is related to an output layer set (OLS), and
wherein the operating point entity group includes information on an index of the output layer set.

10. An apparatus for generating a media file by performing the method of claim 1.

11. A method for generating a media file including video information, comprising:
storing the video information in tracks of a file format;
configuring an operating point entity group including information related to an operating point in the file format; and
generating the media file based on the file format,
wherein the operating point entity group includes information on a maximum picture width for the operating point and information on a maximum picture height for the operating point, and
wherein the information on the maximum picture width and the information on the maximum picture height are used to select the operating point.

12. The method of claim 11, wherein the operating point entity group includes information on a number of operating points.

13. The method of claim 12, wherein the operating point entity group includes information on a mapping of the operating points and the tracks.

14. The method of claim 11, wherein the operating point entity group includes flag information indicating whether frame rate related information is present for the operating point, and
wherein, in response to the flag information being equal to 1, the operating point entity group includes information on an average frame rate for the operating point and information on a constant frame rate for the operating point.

15. The method of claim 11, wherein the operating point entity group includes information on a number of tracks present in the operating point.

16. The method of claim 15, wherein the operating point entity group includes information on an index related to ID values of the tracks present in the operating point.

17. The method of claim 16, wherein the information on the index indicates an index to an entity ID list in an entity group belonging to the operating point.

18. The method of claim 11, wherein the operating point is related to an output layer set (OLS), and
wherein the operating point entity group includes information on an index of the output layer set.

19. An apparatus for generating a media file by performing the method of claim 11.

20. A method for generating a media file including video information, comprising:
storing the video information in tracks of a file format;
configuring an operating point information samples group including information related to an operating point in the file format; and
generating the media file based on the file format,
wherein the operating point information samples group includes information on a maximum picture width for the operating point and information on a maximum picture height for the operating point, and
wherein the information on the maximum picture width and the information on the maximum picture height are used to select the operating point.

21. The method of claim 20, wherein the operating point information samples group includes information on a number of operating points.

22. The method of claim 20, wherein the operating point information samples group includes flag information indicating whether frame rate related information is present for the operating point, and
wherein, in response to the flag information being equal to 1, the operating point information samples group includes information on an average frame rate for the operating point and information on a constant frame rate for the operating point.

23. An apparatus for generating a media file by performing the method of claim 20.
